(19) United States
(12) Patent Application Publication
(10) Pub. No.: US 2016/0091113 A1
(43) Pub. Date: Mar. 31, 2016

(54) IRRIGATION PIPE LAYING MACHINE

(71) Applicant: Kingman Farms, LLC, Las Vegas, CA (US)

(72) Inventors: Frank K. Weigand, La Canada, CA (US); James M. Rhodes, Las Vegas, NV (US); Daniel Leigh Coats, Alamo, CA (US); Jeffrey Gregg Anderson, Santa Clarita, CA (US); Arthur Derby Ahlstone, Ventura, CA (US); Alfredo Tello Besara, JR., Oxnard, CA (US); Dirk Griffith, Las Vegas, NV (US)

(21) Appl. No.: 14/502,516

(22) Filed: Sep. 30, 2014

(51) Int. Cl. F16L 1/036; F16L 1/10; F16L 1/06

(52) U.S. Cl. CPC F16L 1/036; F16L 1/065; F16L 1/10; F16L 2201/60

(57) ABSTRACT

A pipe laying machine is disclosed. The example pipe laying machine includes a platform configured to move continuously relative to the ground and a pipe connector section configured to slide along a portion of length of the platform relative to the platform. The pipe connector section includes an upstream stopper and a downstream pipe connector section configured to slide along a portion of a length of the pipe connector section relative to the pipe connector section. The upstream stopper is configured to prevent a bell mouth of a bell end of an upstream pipe from passing through. The downstream pipe connector section includes a downstream clamp, which is configured to grip a spigot end of a downstream pipe. The downstream pipe connector section is configured to slide toward the upstream pipe to connect the upstream pipe with the downstream pipe.

### BACKGROUND

Underground irrigation piping has been in use since about the 1940s to deliver water to arid areas or reduce the effects of droughts and heat waves. Most commonly, underground irrigation pipes deliver water below ground from a well, reservoir, or other water source to one or more sprinklers or emitters located in a field. The installation of irrigation pipes has become more frequent with changes in climate reducing available ground water in many parts of the world, including the West and Midwest of the United States. Further, as the world's population increases, the use of irrigation pipes has extended farming to relatively dry areas to deliver water for crops and livestock.

Since about the 1950s, irrigation pipes have been made from polyvinyl chloride (“PVC”). The use of PVC enables irrigation pipe to be flexible during installation while maintaining strength to endure over time. While PVC is the most prevalent material, some current irrigation pipes are made from other types of polymers or plastics. Irrigation pipes may be connected together through a number of different methods. For instance, some pipes are configured to be glued together. In other instances, some pipes (i.e., gasketed PVC pipes) are configured to be connected together via an elastomeric radial seal. The gasketed PVC pipes generally require fewer assembly steps and tools (e.g., glue is not applied) compared to pipes that are glued together. Further, the use of the gasket (elastomeric radial seal) is more forgiving regarding installation because pipes may be adjusted after being connected together. In comparison, pipes glued together cannot be easily adjusted because the glue sets relatively quickly. Further gaskets enable pipes to bend at greater angles without compromising the seal between the pipes.

Just as irrigation pipes have been available for about 70 years, the methods for installing or laying the pipe in the ground have been in use for almost the same amount of time. Most installations involve a group of workers tasked with manually connecting the pipes together in a trench. First, a trench digging machine (e.g., a trench excavator) or workers dig a trench in the ground. The workers then place the pipe in the trench and serially connect the pipe together. For example, the workers start at one end, often at the water source and work downstream connecting the pipes together. Each downstream pipe is connected to an open end of an upstream pipe until all of the irrigation pipes have been connected. With gasketed pipe, to make the actual connection, one worker generally holds the upstream pipe in place while one or more workers slide a spigot end of the downstream pipe into a bell end of the upstream pipe, often using a crowbar or pick axe to provide leverage. The bell end of the upstream pipe is inserted up to a line or mark on the spigot end of the downstream pipe. This can be a grueling labor intensive process since each pipe may weigh 20 to 100 pounds, with typically hundreds of pipes needing to be connected per day of a project.

FIG. 1 shows an example diagram of commonly used gasketed irrigation pipes.

The diagram includes an upstream pipe 102 that has a bell end 104 and a spigot end (not shown), which is connected to another upstream pipe (located further upstream toward the water source). The diagram also shows a downstream pipe 106 with a bell end (not shown) and a spigot end 108. The bell end 104 of the downstream pipe 106 is open (e.g., not connected to another pipe). The bell end 104 of the upstream pipe 102 includes a bell mouth 110 configured to connect to the spigot end 108 of the downstream pipe 106. To make the connection, workers apply a lubricant (or adhesive in instances where the pipes do not include a gasket) to a portion of the spigot end 108 and manually push the downstream pipe 106 such that the spigot end 108 enters and forms a connection with the bell mouth 110 of the bell end 104 of the upstream pipe 102. The resulting pipe joint is sealed by an elastomeric gasket, which is bonded into the inside diameter of the bell end 104 and/or placed on the outside of the spigot end 108. It should be noted that the elastomeric gasket is bonded into the inside diameter of the bell end for all the pipes during pipe manufacture.

A frequent issue with the connection of gasketed irrigation pipes is that the spigot end 108 may occasionally become over-inserted or under-inserted into the bell mouth 110. Over-inserting causes the spigot end 108 to extend deeper into the bell mouth 110 past a connection point, thereby increasing stress in the connection, particularly during thermal cycling or ground movement. The increased stress at the connection may cause the pipe to crack at the joint, which enables water to leak from the connection. Under-inserting irrigation pipes leads to gaps forming between the bell end 104 of the upstream pipe 102 and the spigot end 108 of the downstream pipe. Under-inserting irrigation pipes also increases the chances of the pipe ends 104 and 108 breaking apart. In either scenario, a great deal of water may be lost from a single misaligned or broken pipe joint. It should be noted that since the pipes are typically buried several feet under the ground after installation, locating a source of a leak, which may not occur until long after installation, is difficult and expensive.

A significant reason for over-inserted or under-inserted irrigation pipes is the manual labor involved in connecting the pipes. For instance, workers often connect the pipe in trenches, where there is not much room to maneuver. A typical trench is only slightly wider than the pipe it carries. Further, the pipe installation often occurs outdoors in hot and arid climates, which increases worker fatigue and the loss of concentration and focus. Additionally, with glued pipe, the adhesive used to bond or seal the connection is fast-setting, which is designed to prevent already connected downstream pipes from becoming over-inserted from the stress of connecting an upstream pipe. However, the fast-setting nature of the adhesive provides only one opportunity for the workers to make a proper connection. Otherwise an improperly set joint has to be cut apart and then a new pipe inserted. With gasketed pipe, to fix an improper connection, the workers have to use a great deal of force to separate the connected pipes. As one can appreciate, fixing an improper connection wastes time, energy, and ultimately money. For these reasons, workers generally disregard improper connections unless the over-insertion or under-insertion is severe.

To provide workers assistance making a proper connection, some irrigation pipe manufacturers apply a visual indicator 112 to the spigot end 108 of the pipe. In FIG. 1, the visual indicator 112 is a black line along a portion of a circumference of the spigot end 108. The visual indicator 112 specifies to what point the downstream pipe 106 is to be inserted into the bell end 104 of the upstream pipe 102. In other words, for a proper connection, the downstream pipe 106 is to be inserted into the into the bell mouth 110 of the downstream pipe 102 until an edge 114 of the bell mouth 110 nearly reaches or touches the visual indicator 112.

The visual indicator 112 may reduce the occurrences of over-insertion and under-insertion, however, it does not entirely eliminate the issue. The visual indicator 112 does not physically prevent over-insertion or under-insertion. Additionally, workers may disregard the visual indicator 112.

As an alternative to manual labor, some companies offer machines to connect and install irrigation pipe. For example, one known company offers a backhoe shovel attachment that is configured to grip irrigation pipe. While this machine is able to move the pipe with relative ease, it is a relatively slow process to properly position the backhoe arm to connect the downstream pipe 106 to the upstream pipe 102. Further, the operator has relatively little feedback (other than visual confirmation) regarding whether the pipes are over-inserted or under-inserted, even with use of the visual indicator 112. Moreover, the use of the backhoe arm attachment may connect the pipes with such force that causes further upstream pipe connections to break or become over-inserted.

Other known machines are configured to enable workers (or mechanical equipment) to connect irrigation pipe above a trench. These machines then allow the connected pipe to be lowed into the trench as the machines move downstream. However, as shown in the diagram 200 of FIG. 2, irrigation pipe experiences relatively high stress when bent above a certain angle. The diagram 200 shows that irrigation pipe lowered into a trench is bent above this angle at a longitudinal distance 202 (e.g., 20 to 30 feet from the top of a trench) before the pipe reaches the ground. The stress at this angle may disrupt or otherwise break pipes joints, resulting in water leakage. The stress may also cause over-inserted or under-inserted pipes to completely break apart. Further, while these known machines enable irrigation pipe to be connected above ground, these machines cannot regulate the over-insertion or under-insertion of irrigation pipes.

Additionally, these known machines are configured to operate in a start-and-stop manner. For instance, a machine moves to a first position and stops while workers connect irrigation pipe. After the connection is made, the known machine starts moving again to the next downstream position, where another connection is made. This constant starting and stopping wastes time and money.

### SUMMARY

The present disclosure provides a new and innovative irrigation pipe laying machine that solves at least some of the issues discussed above by including functionality to automatically and consistently make a proper connection between an upstream pipe and a downstream pipe with minimal effort by workers. The example pipe laying machine disclosed herein is configured to connect and lower irrigation pipe while moving at a constant velocity without stopping during or between pipe connections. Such a configuration enables the example pipe laying machine to operate as a continuous conveyor system.

Generally, to connect and lay irrigation pipe, the irrigation pipe cannot move longitudinally. Any longitudinal movement of connected irrigation pipe stresses the joints resulting in disconnected pipe. The example pipe laying machine disclosed herein is configured to continuously move downstream while connecting irrigation pipe by using two or more sections (or platforms) that move in an opposite upstream direction while holding or gripping the irrigation pipe to be connected. The movement of the sections in the opposite direction of the downstream movement of the pipe laying machine enables the irrigation pipe to be gripped and connected while remaining stationary relative to the ground.

The example pipe laying machine includes a first section (e.g., a pipe connector section) that includes a stopper configured to grip an upstream pipe. Upon contact with a bell mouth of the upstream pipe, the first section is configured to move upstream at a velocity substantially equal (e.g., equal to or within a few miles per hour) to the downstream velocity of the pipe laying machine, thereby causing the upstream pipe to remain stationary relative to the ground. The example pipe laying machine includes a second section (e.g., a downstream pipe connector section) that includes a clamp configured to grip a downstream pipe. The second section is positioned on or connected to the first section such that the second section moves upstream when the first section moves upstream. However, the second section is configured to move more quickly upstream relative to the first section. This configuration enables the second section to insert the downstream pipe into the upstream pipe while the first section is also moving upstream.

After a connection is made, the stopper on the first section and the clamp on the second section are moved to open positions, releasing the connected irrigation pipe. At this point, there is nothing connected to the irrigation pipe to cause the pipe to move downstream. With the stopper and the clamp in the open position, the first section and the second section are returned to their original downstream positions while the connected pipe is lowered into the trench as the pipe laying machine continues to move downstream. The above-described process repeats for the subsequent downstream pipe.

To reduce the stress of laying the connected pipe into the ground, the example pipe laying machine includes a rail (or rail system) that guides and gradually lowers irrigation pipe into a trench. This gradually lowering of the pipe along the rail prevents the pipe from bending at undesired angles, thereby preserving the integrity of the joint. The use of the rail in conjunction with the first and second sections, the stopper, and the clamp enables the example pipe laying machine to continuously connect and lower irrigation pipe into a trench without stopping.

In an example embodiment, an example pipe laying machine includes a platform including a first end and a second end, the platform being configured to move relative to the ground. The pipe laying machine also includes a pipe connector section configured to slide along a portion of length of the platform relative to the platform. The pipe connector section includes an upstream stopper located adjacent to a first end of the pipe connector section and a downstream pipe connector section configured to slide along a portion of a length of the pipe connector section relative to the pipe connector section. The example downstream pipe connector section includes a downstream clamp. The upstream stopper is configured in a closed position to prevent a bell mouth of a bell end of an upstream pipe from passing through. The downstream clamp is configured in a closed position to grip a spigot end of a downstream pipe. Further, the downstream pipe connector section is configured to slide toward the upstream pipe to connect the bell end of the upstream pipe with the spigot end of the downstream pipe after the downstream clamp is placed into the closed position.

In another example embodiment, a method of laying pipe includes moving a platform in a downstream direction substantially continuously at a first velocity, the platform including a pipe connector section configured to slide along a portion of a length of the platform relative to the platform. The example method also includes moving an upstream stopper to a closed position to prevent a bell mouth of a bell end of an upstream pipe from passing through, the upstream stopper being located on the pipe connector section. The example method further includes moving the pipe connector section from a first position on the platform to a final position on the platform in an upstream direction at the first velocity after the upstream stopper contacts the bell mouth of the upstream pipe. The example method moreover includes moving a downstream clamp to a closed position on a spigot end of a downstream pipe, the downstream clamp being located on a downstream pipe connector section configured to slide along a portion of a length of the pipe connector section relative to the pipe connector section. The example method additionally includes moving the downstream pipe connector section in the upstream direction at a second velocity from a first position on the pipe connector section to a second position on the pipe connector section to insert the downstream pipe into the upstream pipe while the pipe connector section is moving at the first velocity, the second velocity being greater than the first velocity.

Additional features and advantages of the disclosed system, method, and apparatus are described in, and will be apparent from, the following Detailed Description and the Figures.

### BRIEF DESCRIPTION OF THE FIGURES

FIG. 1 shows an example diagram of widely used irrigation pipes.

FIG. 2 shows an example diagram of stress experienced by an irrigation pipe while being lowered into the ground.

FIG. 3 shows a diagram of an example irrigation pipe laying environment including a pipe laying machine, according to an example embodiment of the present disclosure.

FIG. 4 shows a diagram of a pipe support section of the pipe laying machine of FIG. 3, according to an example embodiment of the present disclosure.

FIG. 5 shows a diagram of an enlarged view of a pipe connection apparatus of the example pipe laying machine of FIG. 3, according to an example embodiment of the present disclosure.

FIG. 6 shows a diagram of a clamp of the example pipe connection apparatus of FIG. 5, according to an example embodiment of the present disclosure.

FIGS. 7 and 8 show an example sequence for connecting a downstream irrigation pipe to an upstream irrigation pipe while the example pipe laying machine of FIG. 3 is continuously moving downstream, according to an example embodiment of the present disclosure.

FIG. 9 shows a diagram of the pipe connection apparatus of FIG. 3 at Step B of the sequence of FIGS. 7 and 8, according to an example embodiment of the present disclosure.

FIG. 10 shows a diagram of the pipe connection apparatus of FIG. 3 at Step C of the sequence of FIGS. 7 and 8, according to an example embodiment of the present disclosure.

FIG. 11 shows a diagram of the pipe connection apparatus of FIG. 3 at step E of the sequence of FIGS. 7 and 8, according to an example embodiment of the present disclosure.

FIG. 12 shows a diagram of the pipe connection apparatus of FIG. 3 at Step F the sequence of FIGS. 7 and 8, according to an example embodiment of the present disclosure.

FIG. 13 shows a diagram of an example plunger configured to push and/or align a downstream irrigation pipe with an upstream irrigation pipe prior to connection by the pipe connection apparatus of FIGS. 3 and 5, according to an example embodiment of the present disclosure.

FIG. 14 shows a diagram of an example magazine of the pipe laying machine of FIGS. 3 and 5, according to an example embodiment of the present disclosure.

FIGS. 15 and 16 show an example joint clamp, according to an embodiment of the present disclosure.

FIGS. 17 and 18 illustrate a flow diagram showing an example procedure to continuously connect and lay irrigation pipe, according to an example embodiment of the present disclosure.

### DETAILED DESCRIPTION

The present disclosure relates in general to a method and apparatus for laying irrigation pipe. The example method and apparatus use a conveyor system to connect irrigation pipe above ground on a platform that is aligned with or straddles a trench. The pipe is connected on a rail that extends from the platform into trench. The example method and apparatus use a pipe connector section including a stopper and a downstream pipe connector section having a clamp to grip, connect, and lay irrigation pipe while a pipe laying machine is moving downstream. The pipe connector section is configured to move upstream opposite the downstream motion of the pipe laying machine to hold the irrigation pipe stationary relative to the ground. The downstream pipe connector section is configured to move upstream at a greater velocity than the pipe connector section to make the connection of the downstream pipe to the upstream pipe while the pipe connector section is moving upstream and the pipe laying machine is moving downstream.

The example rail used by the method and apparatus disclosed herein reduces a maximum angle at which the irrigation pipes bend while being inserted into the ground. The rail is configured so that the maximum angle experienced by connected irrigation pipes is less than a manufacturer's recommended misalignment threshold. The use of the connector sections in conjunction with the rail provides an automated pipe connection mechanism that consistently and quickly makes proper connections between upstream and downstream pipes with minimal effort required by workers. The consistent connections of the irrigation pipe reduce (or eliminate) the number of connection fixes that occur over the course of a day. Further, the relatively low effort required by workers enables the process to continue for long periods of time, thereby enabling significant amounts of irrigation pipe to be laid during a day. Moreover, the relatively automated process enables pipe to be connected faster (e.g., 15 to 40 seconds), thereby increasing productivity and reducing installation costs. The relatively automated process accordingly enables irrigation pipe to be connected while the pipe laying machine moves continuously downstream. This constant upstream movement eliminates time wasted from otherwise starting and stopping a pipe laying machine to connect pipes together before placing the pipes into the ground. This constant upstream movement is also conducive for implementing a self-driving or fully automated pipe laying machine.

The example pipe laying machine of the example method and apparatus is configured to connect irrigation pipe ranging in diameter from 3 inches to 27 inches. The spacing of casters, wheels, or rollers (e.g., sliders) on the rail may be adjusted based on the diameter of the pipe being used. The pipe laying machine may use pipe of varying lengths from a few feet to twenty or thirty feet in length. In some instances, different pipe magazines may be used based on the length of the pipe. Further, as disclosed herein, the irrigation pipe is made from PVC. In other embodiments, the irrigation pipe may be made from other materials such as polymers, plastic, rubber, metal, etc. While reference is made specifically to irrigation pipe, the example pipe laying machine may be used to connect and lay pipes for other uses below or above ground. For example, the pipe laying machine may be used for laying utility pipe, pipes for transporting oil or natural gas, and/or pipes for shielding wires.

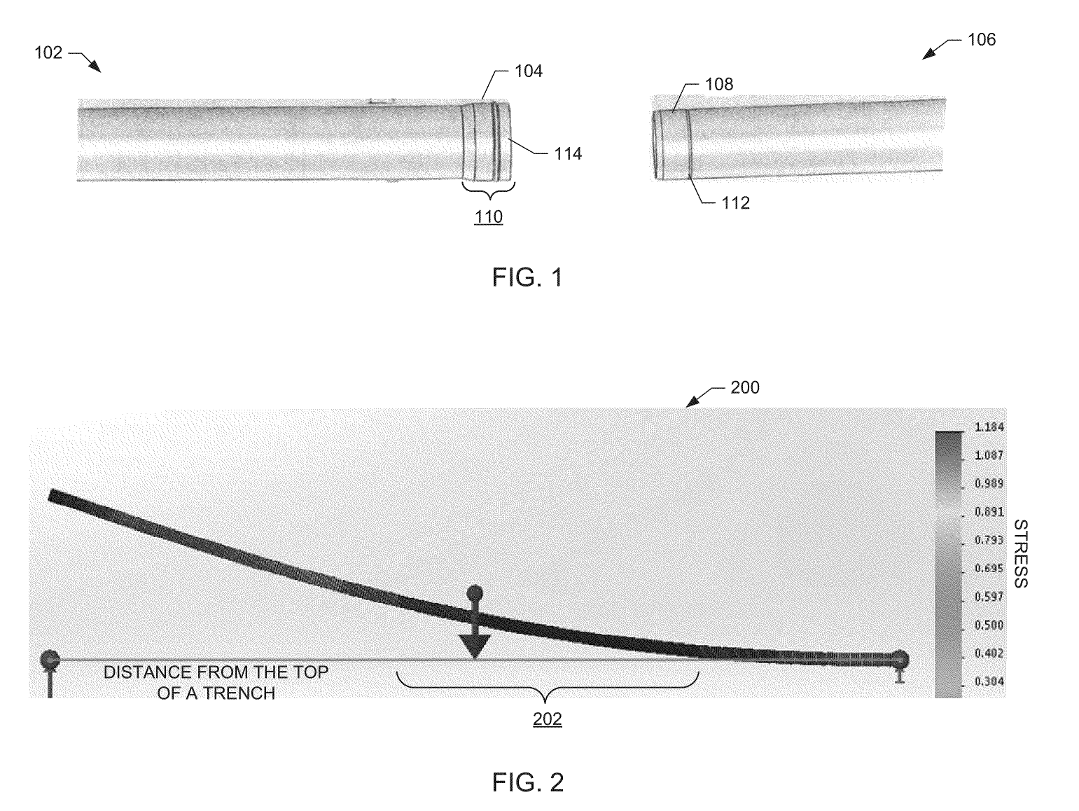

As discussed above, each pipe has two ends, a bell end and a spigot end. The bell end (e.g., the bell end 104 of the upstream pipe 102 of FIG. 1) is configured to have a bell mouth shape to accept the spigot end of an adjacent pipe (e.g., the spigot end 108 of the downstream pipe 106). The spigot end is configured to have, for example, a gasket to engage connection sections within the bell mouth of the bell end. In other instances, the gasket may instead be located within the bell mouth of the bell end. The gasket creates a secure water-tight pipe joint. Alternatively, an adhesive may be applied to the spigot end and/or the bell end to secure and create a water-tight joint in lieu of the gasket.

It should be appreciated that the example method and apparatus disclosed herein may also connect pipes with different shaped ends or other connection mechanisms. For example, the example method and apparatus may connect pipes secured together via joint sections, pipes connected via ring clamps, or pipes welded together. Further, while the example method and apparatus are disclosed as pushing a spigot end of a downstream pipe into a bell end of an upstream pipe, in other embodiments, the example method and apparatus may push a bell end of a downstream pipe onto a spigot end of an upstream pipe.

Reference is made herein to upstream and downstream pipe. As discussed herein, upstream pipe refers to an irrigation pipe that has been connected to a chain of other irrigation pipes. An upstream pipe may be on a rail of the pipe laying machine and/or within a trench. Also, as discussed herein downstream pipe refers to irrigation pipe that has yet to be connected or is in the process of being connected to upstream pipe. The downstream pipe may be on a rail during connection to an upstream pipe. The downstream pipe may also be located in a magazine on a pipe laying machine in queue to be connected.

### Irrigation Pipe Laying Environment

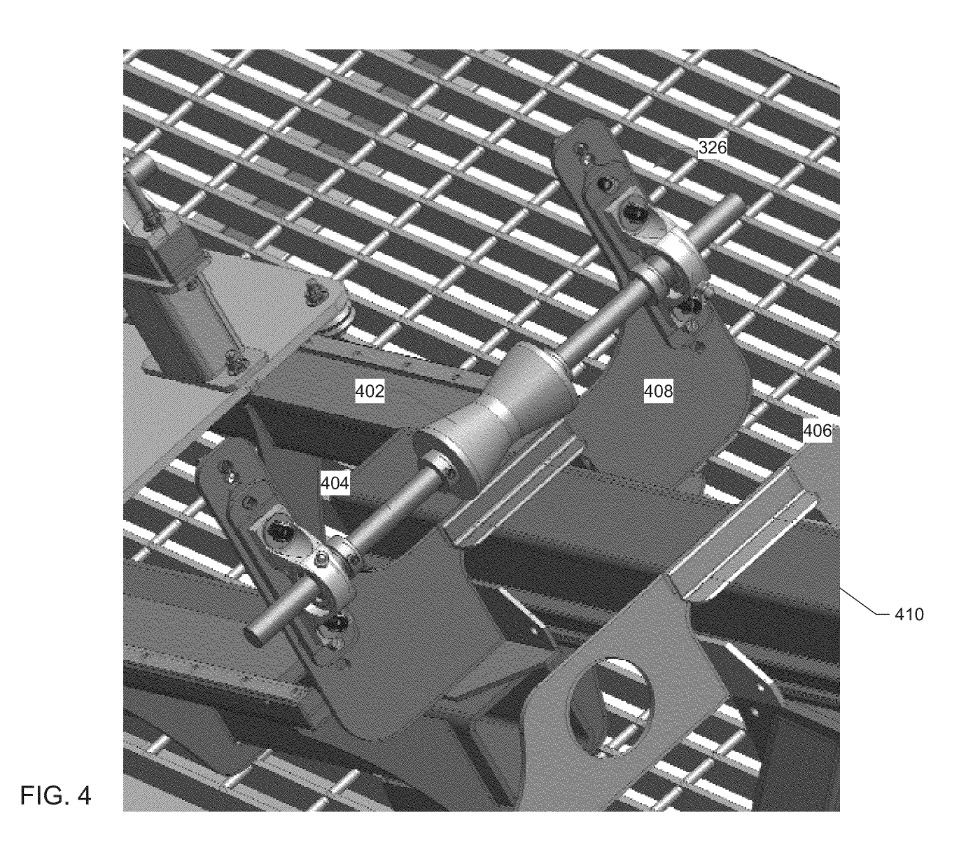

FIG. 3 shows a diagram of an example irrigation pipe laying environment 300 including a pipe laying machine 301, according to an example embodiment of the present disclosure. In this embodiment, the irrigation pipe laying machine 301 includes a platform 302 with a first end 304 and a second end 306. The example platform 302 is configured to move relative to ground 308, which includes a trench 310. The platform 302 includes an undercarriage 312 that includes a support structure and wheels to enable the platform 302 to move over the ground 308. The platform 302 may include any type of wheels and/or be configured to pass over any type of terrain. In other embodiments, the undercarriage 312 may include a suspension system and/or a steering system.

In this embodiment, the trench 310 is formed by a trench digging machine or excavator prior to the platform 302 beginning to connect and lay irrigation pipe. The trench 310 is dimensioned based on a size of a shovel used to dig the trench 310. Generally, the trench 310 is just large enough to accommodate the irrigation pipe. In some embodiments, the platform 302 may be connected to a trench digging machine and/or be integrated with the functionality to dig the trench 310 while connecting and laying irrigation pipe.

The example platform 302 of FIG. 3 is pulled over the ground 308 by, for example, a tractor 314. The platform 302 is connected to the tractor 314 at the first end 304. The tractor 314 is configured to continuously pull the platform 302 at a first velocity while irrigation pipe is connected and lowered into the trench 310. The first velocity is dependent upon a speed at which irrigation pipe is connected, ranging from, for example, 2 miles per hour (“mph”) to 4 mph. In other embodiments, the tractor 314 may be replaced by a truck or other propulsion source. In yet other embodiments, the platform 302 may include functionality to be self-propelled. For example, the platform 302 could include an engine, transmission, and drivetrain to enable an operator to drive the platform 302 over the ground 308.

The example platform 302 of FIG. 3 also includes a rail system 316 that is configured to support and lay the irrigation pipe 318 into the trench 310. In this embodiment, the rail system 316 has a total length of about 95 feet and is inclined to enable the irrigation pipe 318 to be gradually lowered into the trench 310 as the pipe laying machine 301 moves upstream. The rail system 316 includes a platform rail section 316a and a trench rail section 316b. Collectively, the platform rail section 316a and the trench rail section 316b are referred to herein as a rail. The platform rail section 316a has a length of about 60 feet and the trench rail section 316b has a length of about 35 feet. The length of the platform rail section 316a may vary based on a length of the platform 302. The length of the trench rail section 316b may vary based on a desired slope angle 319 of the irrigation pipe 318 being laid into the trench 310. As discussed below, the slope angle 319 is the angle formed by the rail system 316 relative to a base or bottom of the trench 310. A longer rail system 316 generally reduces the slope angle 319, thereby reducing the joint angle between pairs of pipes.

The platform rail section 316a is configured to support the irrigation pipe 318 on the platform 302. The platform rail section 316a is positioned relative to a pipe connection apparatus 320 to support a downstream irrigation pipe 318a and an upstream irrigation pipe 318b during connection. In particular, the platform rail section 316a is configured to feed the downstream irrigation pipe 318a into the pipe connection apparatus 320 and support the upstream irrigation pipe 318b during and after a connection.

The example trench rail section 316b is configured to support the irrigation pipe 318 being lowered into the trench 310. The trench rail section 316b is connected to the second end 306 of the platform 302 and receives the irrigation pipe 318 as the pipe traverses from an end of the platform rail section 316a. An end of the trench rail section 316b disposed within the trench 310 may include or be connected to a skid plate to smoothly traverse the bottom of the trench 310.

The rail system 316 is inclined at the slope angle 319 to enable the irrigation pipe 318 to be gradually lowered into the trench 310 as the platform 302 moves downstream relative to the ground 308. The slope angle 319 of the rail 316 is set so as to reduce or minimize stress of the irrigation pipe 318 (and especially the stress experienced by the pipe joints 322 while being lowered in to the trench 310). The slope angle 319 shown in FIG. 3 is approximately 10 degrees. In other examples, the slope angle may vary between 2 to 20 degrees to reduce stress experienced by the irrigation pipe 318 being lowered into the trench 310. In some examples, the slope angle of the rail system 316 may vary at different sections. For example, the platform rail section 316a may have a slope angle of 11 degrees while the trench rail section 316b may have a slope angle of 7 degrees. The decrease in the slope angle 319 gradually aligns the pipe 318 with the flat bottom of the trench 310, further reducing stress.

As shown in FIG. 3, the example rail system 316 is configured with respect to the platform 302 to be aligned with the trench 310. The rail system 316 is positioned in a middle or center of the platform 302 such that the platform 302 in conjunction with the rail system 316 straddles the trench 310. In other embodiments, the rail system 316 may be positioned on a side of the platform 302 such that the rail system 316 is cantilevered or suspended over the trench 310. In some embodiments, the positioning of the rail system 316 relative to the platform 302 may be configurable based on characteristics of the ground 308, the trench 310, and/or a diameter of the irrigation pipe 318.

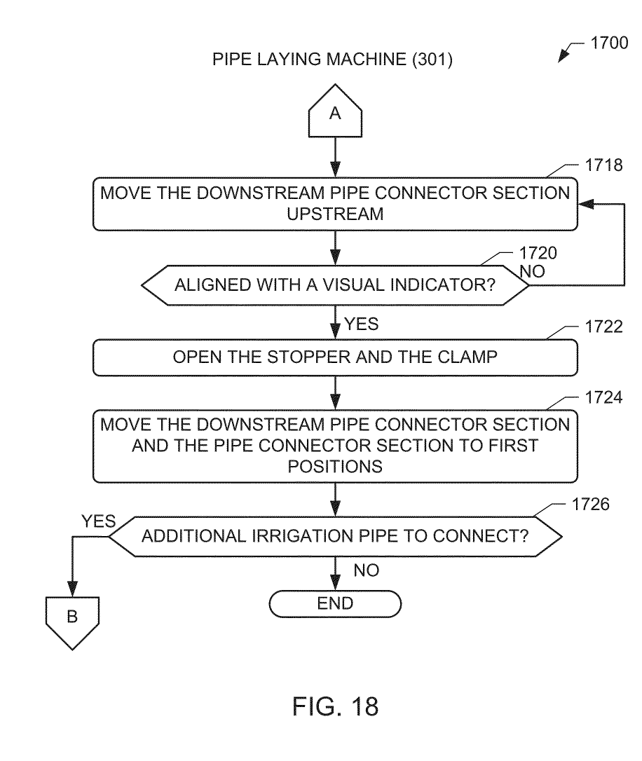

The example pipe laying machine 301 also includes a crane 324 configured to raise and/or lower the trench rail section 316b. For instance, the crane 324 may raise the trench rail section 316b when the pipe laying machine 301 is not in use and/or being transported to a trench. The crane 324 lowers the trench rail section 316b when the platform 302 straddles or is otherwise aligned with the trench 310. In some instances, the crane 324 may enable the slope angle 319 of the trench rail section 316b to be adjusted by lowering or raising the trench rail section 316b. The amount of adjustment of the trench rail section 316b may be based on, for example, a depth of the trench 310. As discussed in more detail below in conjunction with FIGS. 16 and 17, the crane 324 may also be used to open and/or reel joint clamps back to the platform 302.

It should be appreciated that the irrigation pipes 318 do not move longitudinally within the trench 310. The downstream movement of the platform 302 and the rail system 316 relative to the ground 308 causes the stationary irrigation pipes 318 to be lowered into the trench 310. For instance, as the platform 302 moves downstream, the rail system 316 likewise moves downstream. The downstream irrigation pipe 318a is aligned with, for example, the platform rail section 316a when the platform 302 is at a first position and aligned with the trench rail section 316b when the platform is at a second position downstream from the first position. At the second position the irrigation pipe 318a is closer to a bottom of the trench 310. As the platform 302 and the rail system 316 move further downstream, the irrigation pipe 318a lowers into the trench 310 until it is completely separate from the rail system 316. At this point, the irrigation pipe 318a rests on a floor, base, or bottom of the trench 310.

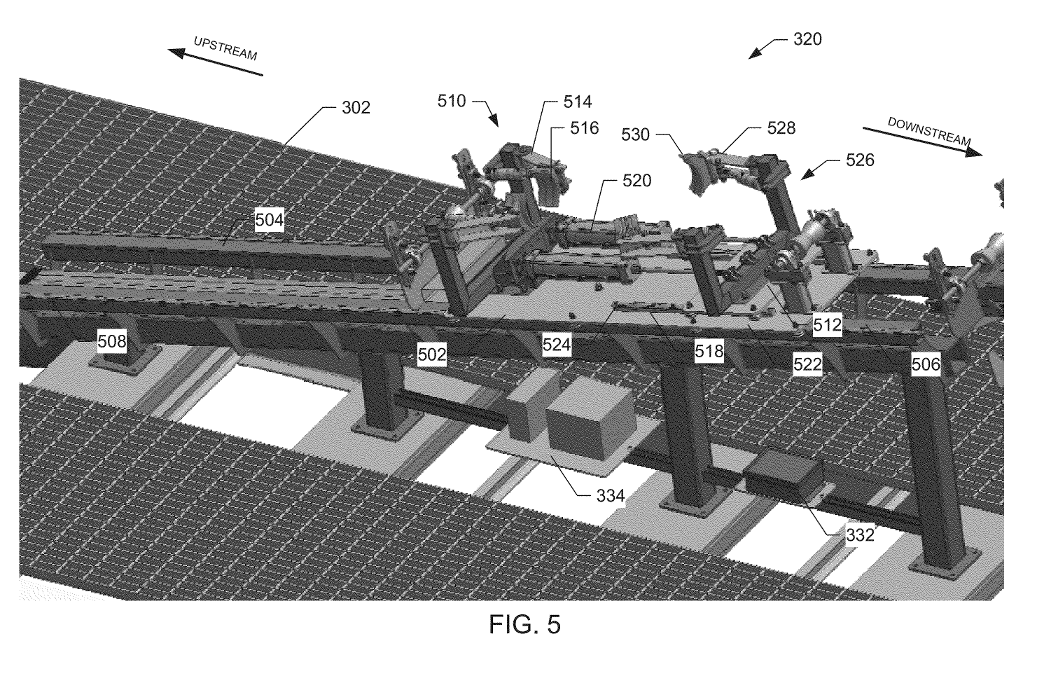

As shown FIGS. 3 and 4, the example rail system 316 includes pipe support sections 326 positioned periodically along the rail. The number and positioning of the pipe support sections 326 may be based on, for example, a length of the irrigation pipe 318, a weight of the irrigation pipe 318, a length of the rail system 316, etc. For example, additional pipe support sections 326 may be added to the rail system 316 for relatively heavier or shorter irrigation pipe.

As shown in more detail in FIG. 4, the pipe support section 326 includes a roller 402 attached to an axle 404. The example roller 402 is configured to contact and support the irrigation pipe 318 while enabling the rail system 316 to move relative to the stationary irrigation pipe 318. The rollers 402 may include any wheel, slider, caster, etc. to enable the rail system 316 to move relative to the irrigation pipe 318. The example axle 404 is connected to a base 406 via a connector 408. The example base 406 secures the roller 402 to a member 410 of the rail system 416. The example connector 408 enables the axle to be rotatably connected to the base 406. A user may open the connector 408 to easily replace the roller 402 on the axle 404. The size of the roller 402 selected may be based on, for example, a diameter of the irrigation pipe 318. The example support section 326 accordingly enables the rail system 316 to be easily configured for different diameter irrigation pipe without signification modification.

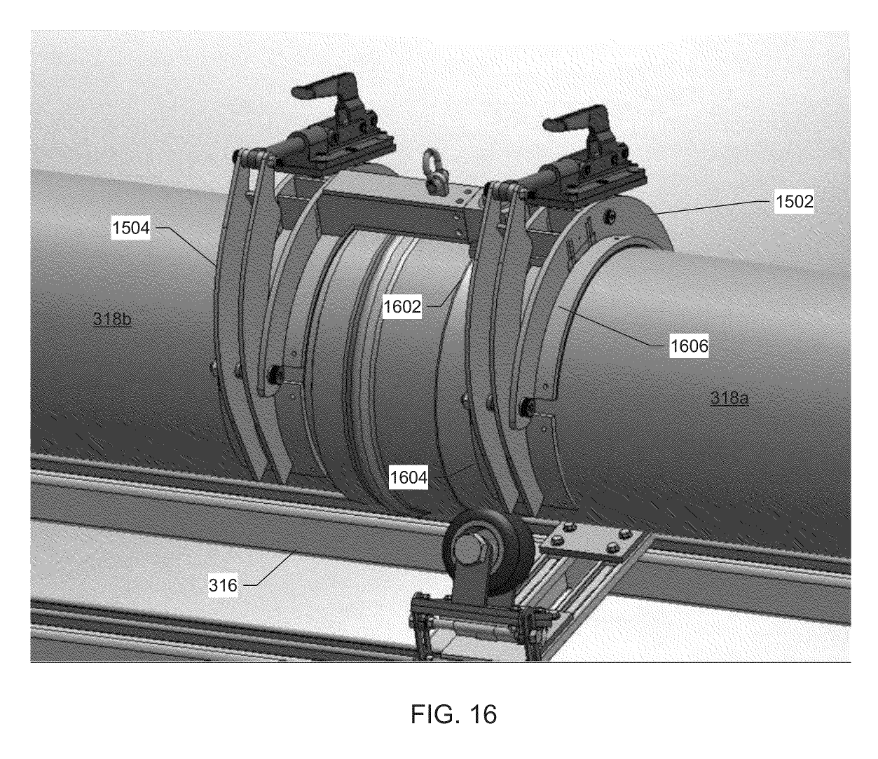

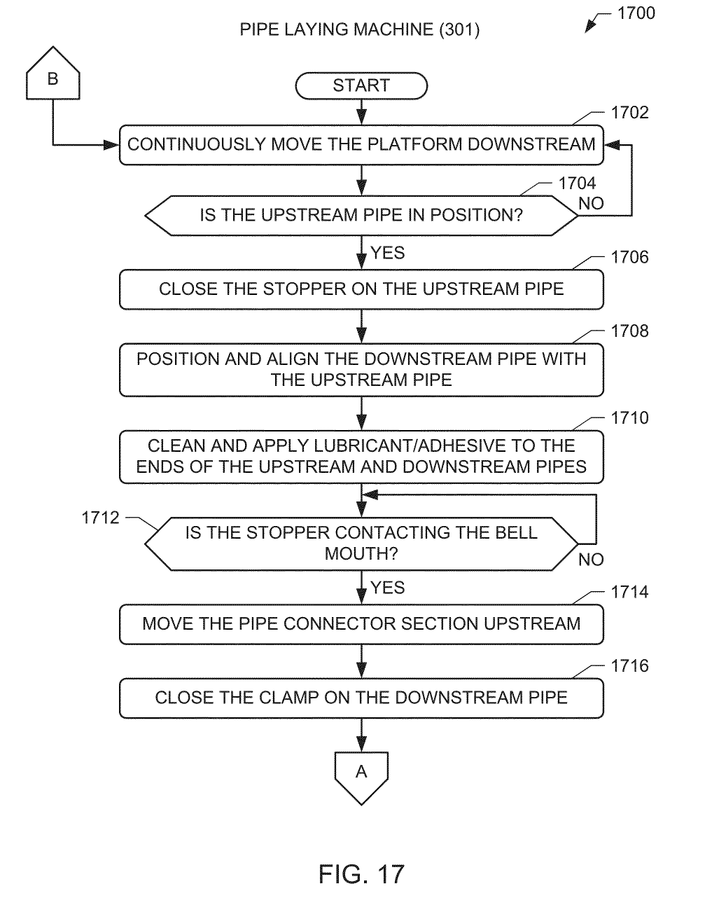

Returning to FIG. 3, the example pipe laying machine 301 also includes downstream pipe holders 328. The example downstream pipe holders 328 are configured to retain a next downstream pipe in place until the rail system 316 is available to receive the irrigation pipe. A plunger or other type of actuator may push or otherwise move an irrigation pipe from the downstream pipe holders 328 to the platform rail section 316a. Alternatively, the pipe may be manually moved to rail section 316a. In some embodiments, the downstream pipe holders 328 may include a stop that may be opened to enable the next downstream pipe to roll onto the platform rail section 316a. The downstream pipe holders 328 may be connected to a magazine that stores additional upstream pipes. FIGS. 14 and 15 show example embodiments of a magazine that may be used with the pipe laying machine 301 of FIG. 3.

The example pipe laying machine 301 further includes power and control functionality. For instance, the pipe laying machine 301 includes a compressor 330 to provide compressed air for pneumatic control of the pipe connection apparatus 320. The pipe laying machine 301 also includes a pneumatic controller 332 configured to regulate or otherwise provide pneumatic control for the pipe connection apparatus 320 based on input or instructions from a controller 334. The example controller 334 may include a server, processor, computer, etc. that includes instructions stored thereon that are configured when executed to cause the controller 334 to perform one or more predefined routines to connect irrigation pipe and/or control operation of the platform 302 and/or tractor 314. A generator 336 provides power to the pipe connection apparatus 320, the compressor 330, the pneumatic controller 332, and/or the controller 334.

In addition to supporting the rail 316, the compressor 330, and the pneumatic controller 332, the controller 334, and the generator 336, the example platform 302 is also configured to provide a work area. For instance, the first end 304 and/or the second end 306 of the platform 302 may include enough space to enable workers to cut pipe and/or install fittings such as Tees, elbows, reducers, etc. typical for an irrigation system. The fittings may be connected to the upstream irrigation pipe 318b via the pipe connection apparatus 320 and gradually lowered into the trench 310 via the rail 316. Alternatively, the fittings may be glued to the bell end 104 of the upstream pipe 318b.

### Pipe Connection Apparatus

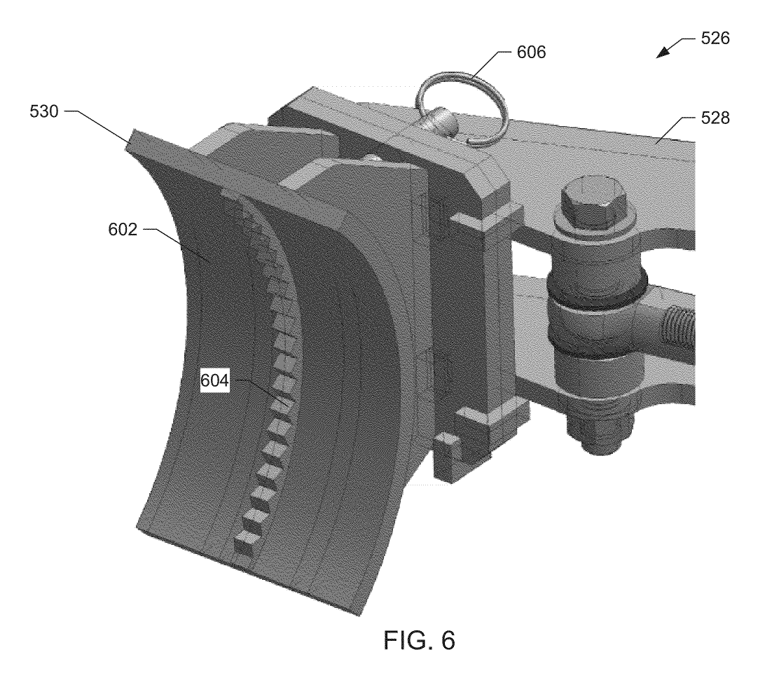

FIG. 5 shows a diagram of an enlarged view of the example pipe connection apparatus 320 of FIG. 3, according to an example embodiment of the present disclosure. The example pipe connection apparatus 320 is configured to operate in conjunction with the controller 334 and the pneumatic controller 332 to grip and connect the irrigation pipe 318 while the pipe laying machine 301 is moving in the downstream direction. The example pipe connection apparatus 320 of FIG. 5 includes a pipe connector section 502 configured to move along a track 504 connected to the platform 302. The pipe connector section 502 is configured to move between a first position 506 located at a downstream side of the track 504 and a second or final position 508 located at an upstream side of the track 504.

The example pipe connector section 502 is moved between the first position 506 and the second position 508 via one or more pneumatic actuators controlled by the pneumatic controller 332. For example, a first pneumatic actuator may be configured to push the pipe connector section 502 upstream from the first position 506 to the second position 508 and a second pneumatic actuator may be configured to push the pipe connector section 502 downstream from the second position 508 to the first position 506. The first pneumatic actuator may be located on a downstream side of the pipe connector section 502 and the second pneumatic actuator may be located on an upstream side of the pipe connector section 502. In an alternative embodiment, the first and second pneumatic actuators may be replaced with a pneumatic piston configured to push and/or pull the pipe connector section 502 between the first position 506 and the second position 508 along the track 504. The pipe connector section 502 may also be connected to a counterweight disposed in proximity to the track 504 to reduce, for example, the force needed to move the pipe connector section 504 downstream against the incline of the track 504.

The pipe connector section 502 of FIG. 5 includes a stopper 510 and a downstream pipe connector section 512. The example stopper 510 is configured to move between an open and a closed position. The example stopper 510 may be pneumatically controlled via the pneumatic controller 332. Alternatively, the stopper 510 may be moved between the open and the closed position using an electric motor controlled by, for example, the controller 334.

FIG. 5 shows the stopper 510 in the closed position. In this closed position, stopper arms 514 of the stopper 510 are engaged or otherwise rotated such that stopper pads 516 are in position to engage a bell mouth of the upstream irrigation pipe 318b. It should be noted that in this example the stopper 510 includes a pair of stopper arms 514 and respective stopper pads 516. However, in other embodiments, additional stopper arms and stopper pads may be used. Alternatively, the stopper arms 514 and the stopper pads 516 may be replaced with a stopper ring that changes diameter from an opened to a closed positioned to make contact with the bell mouth of the upstream irrigation pipe 318b.

In contrast to the closed position, in the open position the stopper arms 514 are retracted enabling the irrigation pipe 318 to pass through. It should be appreciated that in this embodiment, the stopper 510 is configured such that the stopper pads 516 do not contact (or grip) a side of the upstream irrigation pipe 318b when in the closed position. Instead, in the closed position, the stopper 510 is configured to enable the upstream irrigation pipe 318b to pass through until the stopper pads 516 contact the protruding bell mouth of the upstream irrigation pipe 318b. In some examples, the stopper pads 516 may contact a leading edge of the bell mouth. In other examples, the stopper pads 516 may contact or grip a raised or protruding portion of the ball mouth.

Reference is made herein to the irrigation pipe 318 passing through the stopper 510. However, as discussed, the upstream irrigation pipe 318b is stationary. Instead, the pipe laying machine 301 (including the pipe connector section 502) moves downstream, which causes the irrigation pipe 318 to pass through the stopper 510.

The example pipe connector section 502 is configured to move longitudinally on the track 504 based on a position of the upstream pipe 318b. For instance, the controller 334 instructs the example pipe connector section 502 to begin moving upstream from the first position 506 to the final position 508 after (or upon) the stopper 510 contacting the bell mouth of the upstream irrigation pipe 318b. As soon as the stopper 510 contacts the bell mouth, the upstream irrigation pipe 318b is secure. Any pulling of the upstream irrigation pipe 318b at this point could pull other upstream pipes apart. To prevent these upstream disconnections, the controller 334 is configured to begin moving the pipe connector section 502 upstream as soon as the stopper pads 516 contact the bell mouth of the upstream irrigation pipe 318b. To prevent the upstream irrigation pipe 318b from moving, the controller 334 instructs the pneumatic controller 332 to move the pipe connector section 502 at substantially the same velocity upstream that the pipe laying machine 301 is moving in the downstream direction.

In some embodiments, the controller 334 may receive a signal from the tractor 314 indicative of a downstream velocity of the platform 302. The controller 334 uses this information to determine a velocity at which the pipe connector section 502 is to move upstream. Alternatively, the controller 334 may include or be in communication with one or more accelerometers, inertial sensors, wheel sensors, etc. to determine the velocity at which the platform 302 is moving downstream. In some embodiments, the controller 334 may adjust the upstream velocity of the pipe connector section 502 responsive to detecting a change to a downstream velocity of the platform 302 and/or the tractor 314. Such a configuration prevents the pipe connector section 502 from disconnecting, stressing, or otherwise misaligning the joints of the upstream irrigation pipes.

Additionally, the controller 334 may be in communication with one or more force sensors at the stopper 510 configured to sense when the bell mouth of the upstream irrigation pipe 318b contacts the stopper pads 516. For instance, a pneumatic actuator within the stopper arm 514 may include a sensor that detects force from the stopper pad 516 contacting the bell mouth. Alternatively, the stopper pad 516 may include a force sensor. Conditioned on receiving a signal indicative of the stopper pad 516 contacting the bell mouth, the controller 334 is configured to instruct the pipe connector section 502 to move upstream at the determined velocity. Alternatively, an operator may actuate a button (e.g., a foot plunger switch) that instructs the controller 334 to begin moving the pipe connector section 502. The operator may also instruct the controller 334 when to move the stopper 510 to the closed position.

In some embodiments, the controller 334 may instruct the pipe connector section 502 to begin moving upstream before the stopper pads 516 contact the bell mouth of the upstream irrigation pipe 318b. For example, after moving the stopper 510 to the closed position, the controller 334 may instruct the pipe connector section 502 to begin moving upstream from the first position 506 at a velocity less than the downstream velocity of the pipe laying machine 301. The purpose of this initial movement is to gradually accelerate the pipe connector section 502. Then, after the stopper pads 516 contact the bell mouth of the upstream irrigation pipe 318b, the controller 334 causes the pipe connector section 502 to accelerate to the velocity of the pipe laying machine 301. This gradual acceleration may reduce the force of the stopper pads 516 contacting the bell mouth, thereby reducing the chances of an upstream pipe disconnection.

In other examples, the pipe connector section 502 may include or be connected to a counterweight that enables the pipe connector section 502 to be moved upstream or downstream with almost no (or very little) force. The contact of the stopper 510 with the bell mouth of the upstream irrigation pipe 318b in conjunction with the downstream movement of the platform 302 causes the pipe connector section 502 to move upstream without placing stress on upstream pipe joints. Such a configuration enables the pipe connector section 502 to be moved upon the stopper 510 contacting the bell mouth without relatively complex sensors, electronics, and/or feedback algorithms.

The example downstream pipe connector section 512 of FIG. 5 is connected to the pipe connector section 502 via a track 518. The downstream pipe connector section 512 is also connected to pneumatic actuators 520, which are configured to control a movement of the downstream pipe connector section 512 along the track 518. The pneumatic controller 332 may provide the pneumatic pressure used to move the pneumatic actuators 520. The downstream pipe connector section 512 is configured to move relative to the pipe connector section 502 to insert the downstream irrigation pipe 318a into the upstream irrigation pipe 318b.

In the example shown in FIG. 5, the track 518 is positioned to enable the downstream pipe connector section 512 to move between a first position 522 and a second position 524 relative to the pipe connector section 502. The controller 334 causes the downstream pipe connector section 512 to move upstream from the first position 522 to the second position 524 to connect the downstream irrigation pipe 318a to the upstream irrigation pipe 318b. The controller 334 causes the downstream pipe connector section 522 to move downstream from the second position 524 to the first position 522 after a connection has been made and the connected pipes are released.

To connect the irrigation pipes 318, the controller 334 and the pneumatic controller 332 are configured to cause the downstream pipe connector section 512 to move upstream along the track 518 at a second velocity greater than the upstream first velocity of the pipe connector section 502. However, the downstream pipe connector section 512 is connected to the pipe connector section 502, which means the downstream pipe connector section 512 is already moving at the first velocity when the pipe connector section 502 is moving. A relative velocity between the pipe connector section 502 and the downstream pipe connector section 512 is equal to the first velocity of the pipe connector section 502 subtracted from the second velocity of the downstream pipe connector section 512. Such a configuration enables the downstream irrigation pipe 318a to be inserted into the upstream irrigation pipe 318b without moving the upstream irrigation pipe 318b relative to the ground while both irrigation pipes 318 are securely gripped by the moving pipe laying machine 301.

To grip the downstream irrigation pipe 318a, the example pipe connector section 512 includes a clamp 526. The example clamp 526 includes a pair of clamp arms 528 connected respectively to clamp pads 530. As shown in FIG. 5, the clamp 526 is in an open position with the clamp arms 528 retracted. The controller 334 in conjunction with the pneumatic controller 332 moves the clamp 526 to a closed position by causing the clamp arms 528 to rotate inward toward a center of the clamp 526. The example controller 334 moves the clamp 526 to the closed position to grip the downstream irrigation pipe 318a. After the clamp 526 grips the downstream irrigation pipe 318a, the controller 334 is configured to instruct the downstream pipe connector section 512 to move upstream from the first position 522 to the second position 524. Moving the downstream pipe connector section 512 to the second position 524 inserts a spigot end of the downstream irrigation pipe 318a into the bell mouth of the bell end of the upstream irrigation pipe 318b.

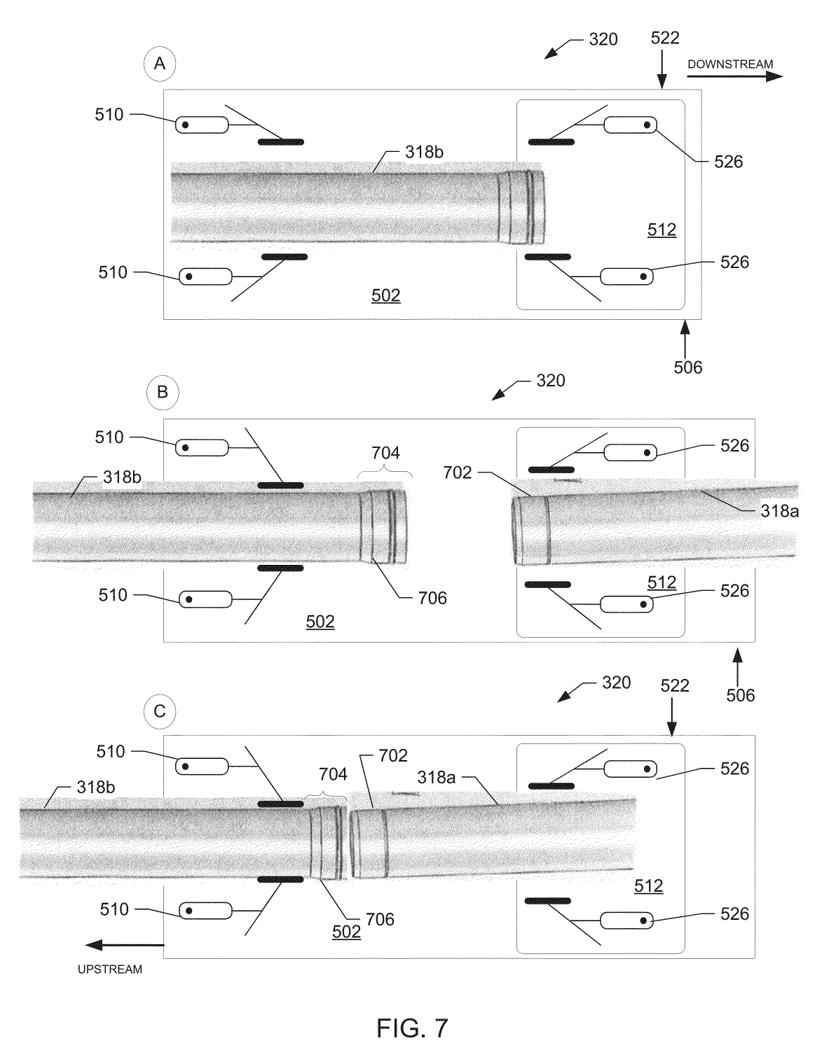

FIG. 6 shows a diagram of the clamp 526 including the clamp pad 530 attached to the clamp arm 528. An interior face 602 of the example clamp pad 530 is configured and/or shaped to grip the upstream irrigation pipe 318a using, for example, serrated teeth 604. The example serrated teeth 604 are configured to engage the exterior of the irrigation pipe 318 without penetrating or otherwise breaking or cracking the pipe. The serrated teeth 604 are configured to grip the irrigation pipe 318 even when the pipe is wet, dirty, or otherwise slippery. While FIG. 6 shows a single column of serrated teeth 604, other examples can include multiple columns and/or rows of serrated teeth.

As shown in FIG. 6, the example clamp pad 530 has a curvature that corresponds to a diameter of the irrigation pipe 318a. The curvature enables a larger surface area of the clamp pad 530 to contact the irrigation pipe 318. The example clamp 426 includes a pin 606 to enable the clamp pad 530 to be easily removed from the clamp arm 528. This configuration enables the clamp pad 530 to be quickly changed based on a diameter of irrigation pipe to be connected and laid into the ground.

Returning to FIG. 5, the example clamp 526 is configured to remain in the closed position until the irrigation pipes 318 are connected. As discussed above in conjunction with FIG. 1, a proper connection occurs when a visual indicator (e.g., the visual indicator 112 of FIG. 1) of a spigot end of the downstream irrigation pipe 318a contacts an edge of a bell mouth of the upstream irrigation pipe 318b. The example track 518 may include a track stop that is configured to prevent the downstream pipe connector section 512 from moving further upstream to a point the irrigation pipes 318 become over-inserted after the pipes are connected. The track stop may be adjustable relative to the track 518 based, for example, on size and spacing of a bell mouth and a visual indicator.

The example pipe connection apparatus 320 may include an operator controlled button that when actuated causes the downstream pipe connector section 512 to move upstream. The operator may depress the button when the bell mouth reaches the visual indicator. A track stop may also be used in this instance to prevent the irrigation pipes 318 from becoming over-inserted.

Alternatively, in some embodiments, the controller 334 may be connected to a vision system that records images of the downstream irrigation pipe 318a. The controller 334 may instruct the downstream pipe connector section 512 to move upstream from the first position 422 until an edge of a bell mouth of the upstream pipe is adjacent to or touching a visual indicator (e.g., the visual indicator 112 of FIG. 1) on the spigot end of the downstream irrigation pipe 318a. Responsive to detecting the bell mouth has reached the visual indicator, the controller 334 instructs the downstream pipe connector section 512 to stop moving upstream to prevent over-insertion of the irrigation pipe 318. At this point, the irrigation pipes 318 are connected and the controller 334 may cause the stopper 510 and the clamp 526 to move to respective open positions, thereby enabling the connected irrigation pipes 318 to pass through and be gradually lowered into the trench 310 via the rail system 316. The controller 334 may also instruct the pipe connector section 502 to return to the first position 506 on the track 504 and the downstream pipe connector section 512 to return to the first position 522 on the track 518.

### Irrigation Pipe Connection Embodiment

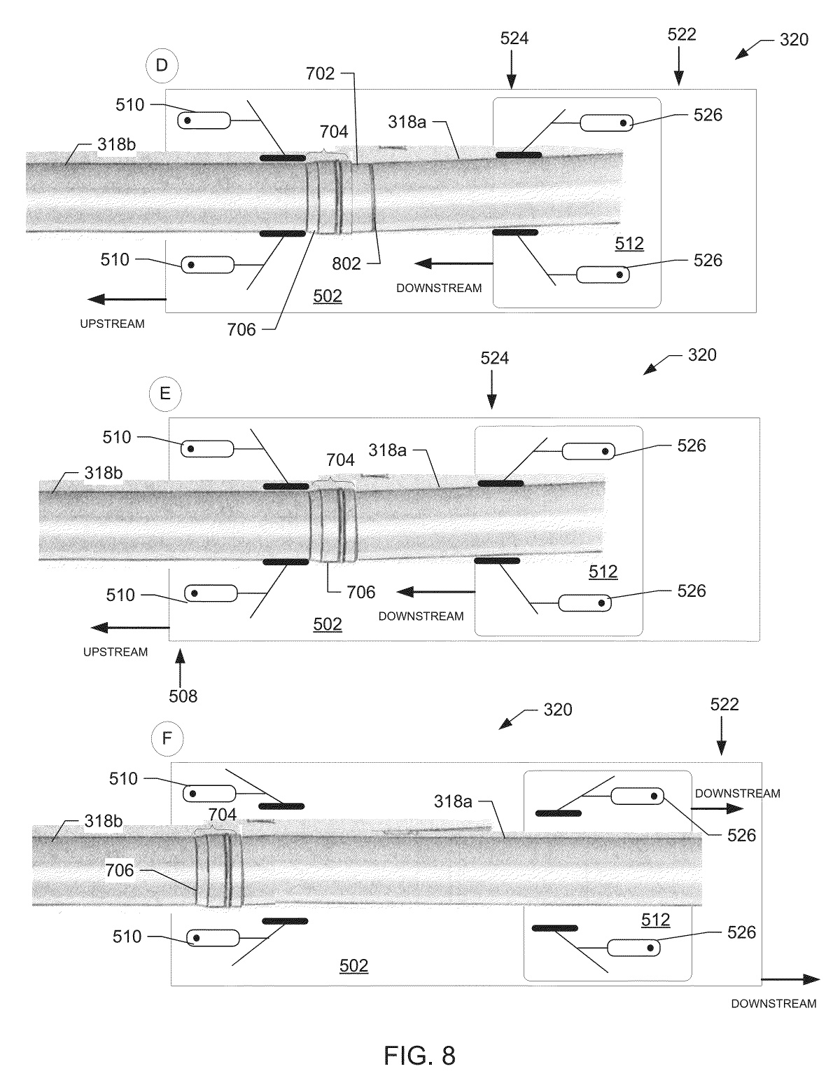

FIGS. 7 and 8 show an example sequence 700 for connecting the downstream irrigation pipe 318a to the upstream irrigation pipe 318b while the example pipe laying machine 301 of FIG. 3 is continuously moving downstream, according to an example embodiment of the present disclosure. At step A, the stopper 510 is in the open position and the clamp 526 is in the open position enabling a spigot end of the upstream irrigation pipe 318b, including an already connected joint, to pass through. Additionally, the downstream pipe connector section 512 is downstream at the first position 522 and the pipe connector section 502 is downstream (or in the process of being moved downstream) at the first position 506. During Step A, the upstream irrigation pipe 318b translates upstream on the rail system 316 through the pipe connection apparatus 320 (in reality the upstream irrigation pipe 318b is stationary and the rail system 316 moves downstream) as the platform 302 moves downstream.

At Step B, the upstream irrigation pipe 318b is positioned with respect to the pipe connection apparatus 320 such that the controller 334 causes the stopper 510 to move to the closed position. However, as discussed, the stopper 510 is configured in the closed position to enable the upstream irrigation pipe 318b to continue to pass through. Additionally, at Step B the downstream irrigation pipe 318a is loaded onto the platform rail section 316a and pushed or otherwise moved into the pipe connection apparatus 320. In some instances, one or more operators may position the downstream irrigation pipe 318a. Alternatively, a plunger may push a bell end of the downstream pipe into the pipe connection apparatus 320. Once in position, an exterior surface of a spigot end 702 of the downstream irrigation pipe 318a is lubricated. Additionally or alternatively, an adhesive is applied to the exterior surface of the spigot end 702 depending on the type of pipe (e.g., gasketed pipe). In some instances, an adhesive and/or lubricant may also be applied to an interior surface of a bell end 704 of the upstream irrigation pipe 318b.

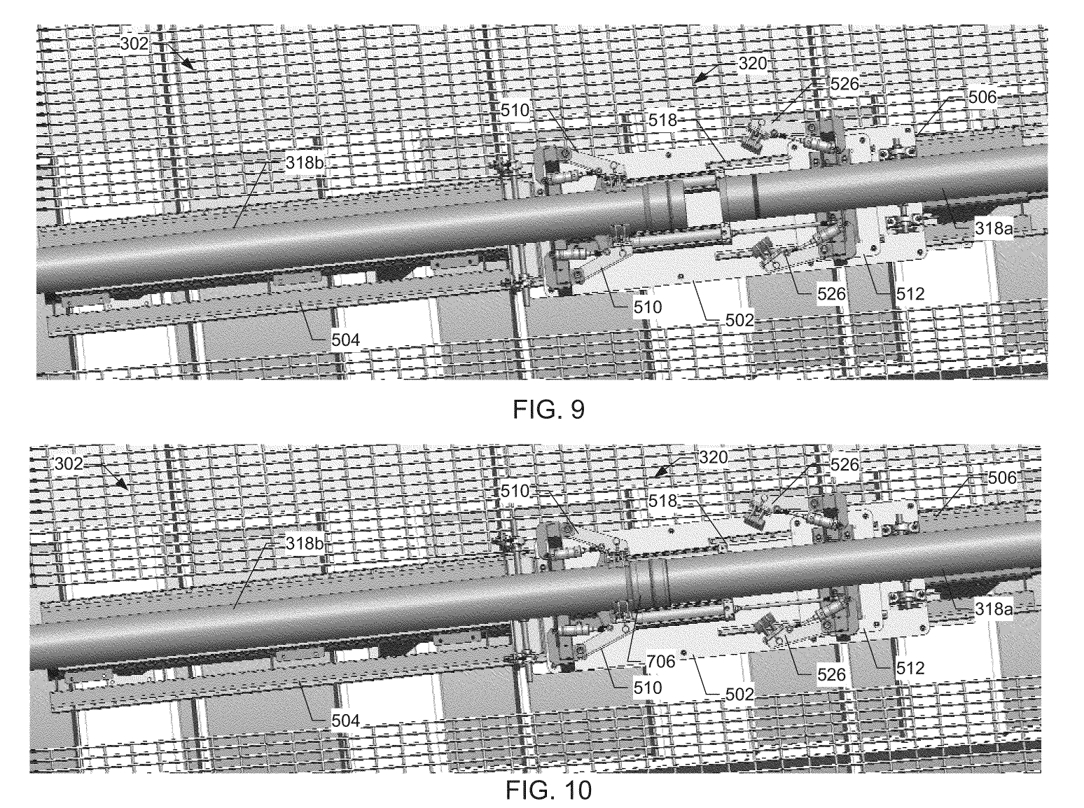

FIG. 9 shows a diagram of the pipe connection apparatus 320 at Step B of the sequence 700 of FIG. 7, according to an example embodiment of the present disclosure. As shown, the stopper 510 is moved to the closed position around the upstream irrigation pipe 318b. Additionally, the clamp 526 is in the open position enabling the downstream irrigation pipe 318a to be positioned and/or aligned with respect to the upstream irrigation pipe 318b. Also, as shown, the pipe connector section 502 is located at the first position 506 along the track 504 and the downstream pipe connector section 512 is located at the first position 522 along the track 518.

Returning to FIG. 7, next at Step C, the upstream pipe 318b continues to translate upstream until a bell mouth 706 at the bell end 704 of the upstream irrigation pipe 318b contacts the stopper 510 in the closed position. Once the stopper 510 is contacted, the upstream irrigation pipe 318b is secured the pipe connector section 502 is moved in the upstream direction (e.g., moved via the controller 334). Also during Step C, the downstream irrigation pipe 318a is pushed upstream such that the spigot end 702 is in contact or close proximity to the bell end 704 of the upstream irrigation pipe 318b. Additionally, a bevel of a leading end of the spigot end 702 of the downstream irrigation pipe 318a may be aligned with (or slightly inserted within) the bell mouth 706 of the bell end 704 of the upstream irrigation pipe 318b. It should be appreciated that the clamp 526 is not yet moved into the closed position at this step.

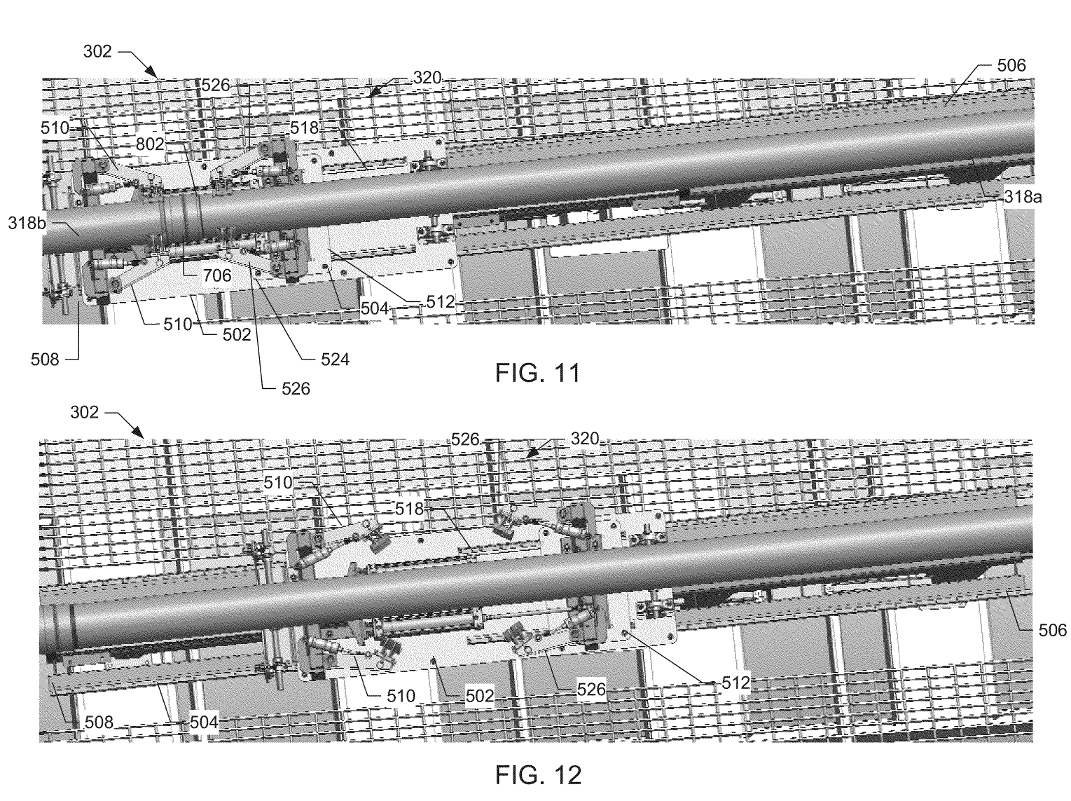

FIG. 10 shows a diagram of the pipe connection apparatus 320 at Step C of the sequence 700 of FIG. 7, according to an example embodiment of the present disclosure. As shown, the downstream irrigation pipe 318a is moved and/or aligned with the upstream irrigation pipe 318b. Additionally, the stopper 510 contacts the bell mouth 704, thereby securing the upstream pipe 318a. Conditioned on the stopper 510 contacting the bell mouth 704, the pipe connector section 502 begins to move upstream along the track 504.

The example sequence 700 continues in FIG. 8, where at Step D the controller 334 causes the clamp 526 to move to the closed position. After the clamp 526 is closed, the controller 334 causes the downstream pipe connector section 512 to begin moving in the upstream direction from the first position 522 to the second position 524. The upstream movement of the downstream pipe connector section 512 causes the spigot end 702 of the downstream irrigation pipe 318a to become inserted into the bell mouth 706 of the upstream irrigation pipe 318b. In other embodiments, an operator may press or otherwise activate a switch (e.g., a foot switch), which causes the clamp 526 to move to the closed position. The activation of the switch may also cause the downstream pipe connector section 512 to move upstream relative to the pipe connector section 502.

At Step E, the example controller 334 causes the downstream pipe connector section 512 to continue moving upstream relative to the pipe connection section 502 until a visual indicator 802 of the spigot end 702 of the downstream irrigation pipe 318a contacts an edge of the bell mouth 706 of the upstream irrigation pipe 318b. Once the visual indicator 802 reaches the bell mouth 706, the controller 334 opens the clamp 526 and stops the downstream pipe connector section 512 from moving. In some instances, the controller 334 may first open the clamp 526 to ensure the downstream irrigation pipe 318a is not over-inserted while the downstream pipe connector section 512 decelerates to a stop. Alternatively, the controller 334 may stop the downstream pipe connector section 512 then (sometimes concurrently) move the clamp 526 to the open position.

In embodiments where an operator uses a switch to move the downstream pipe connector section 512, the operator may release the switch causing the clamp 526 to move to the open position. Releasing the switch may also stop the downstream pipe connector section 512 from moving upstream. In yet other embodiments, the controller 334 may use images from a vision system to determine when the visual indicator 802 reaches the bell mouth 706 and accordingly move the clamp 526 to the open position and stop the downstream pipe connector section 512.

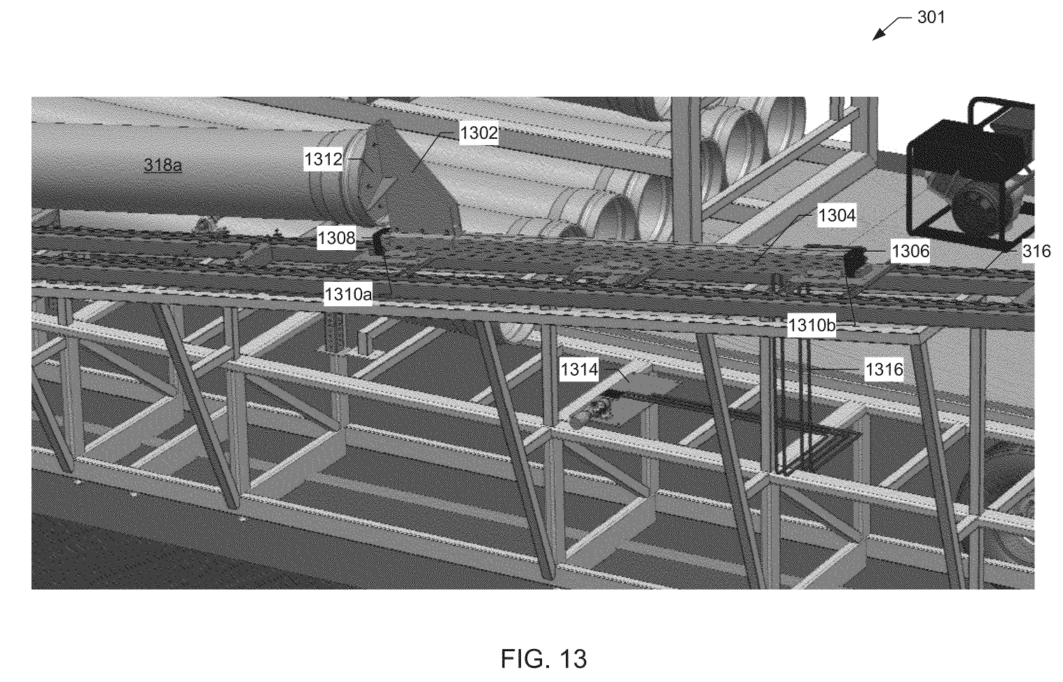

FIG. 11 shows a diagram of the pipe connection apparatus 320 at Step E of the sequence 700 of FIG. 8, according to an example embodiment of the present disclosure. As shown in FIG. 11, the pipe connector section 502 has moved upstream to the final position 508 and the downstream pipe connector section 512 has moved to the second position 524. At this point, the visual indicator 802 of the downstream irrigation pipe 318a is contacting the bell mouth 706 of the upstream irrigation pipe 318b, indicative of a secure pipe joint.

As can be appreciated by viewing FIGS. 10 and 11 together, the pipe connector section 502 moves upstream as the platform 302 moves downstream. The pipe connector section 502 moves upstream relative to the platform 302 by traveling along the track 804. This upstream movement of the pipe connector section 502 prevents the upstream irrigation pipe 318b from moving, thereby preserving upstream pipe connections while at the same time securing the upstream irrigation pipe 318b for connection to the downstream irrigation pipe 318a. Further, as shown between FIGS. 10 and 11, the downstream pipe connector section 512 moves upstream relative to the pipe connector section 502 to push the downstream pipe 518a into the bell mouth 706 of the upstream pipe 518b.

Returning to FIG. 8, the example sequence 700 ends at Step F where the controller 334 causes the stopper 510 to move to the open position. At this point, the clamp 526 has already been moved to the open position, as discussed above in Step E. In some embodiments, the controller 334 may cause the stopper 510 to move to the open position at the same time or immediately after the clamp 526 is moved to the open position. The opening of the stopper 526 enables the bell mouth 706 and the downstream irrigation pipe 518a to pass through as the pipe laying machine 301 continues to move downstream.

During Step F, the example controller 334 also causes the pipe connector section 502 to stop moving upstream at the final position 508 and begin moving upstream back to the first position 506. The controller 334 also causes the downstream pipe connector section 512 to move downstream back to the first position 522. If there is an additional irrigation pipe to connect, the sequence then returns to Step A and repeats. Alternatively, the sequence ends if there are no additional irrigation pipes to connect.

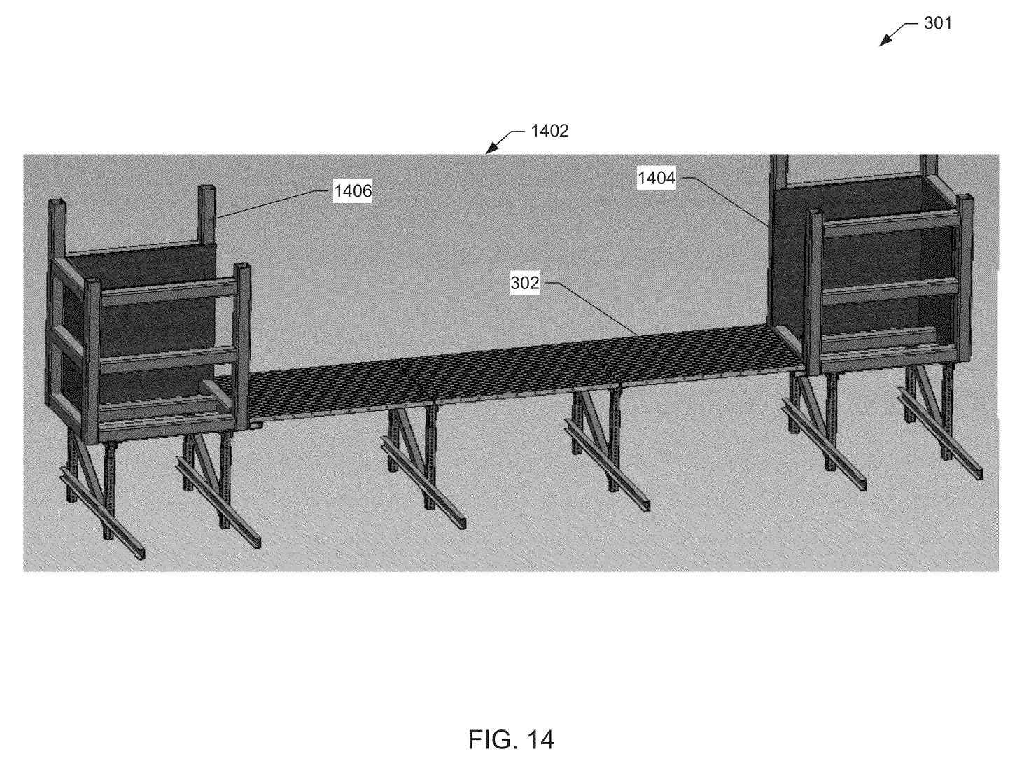

FIG. 12 shows a diagram of the pipe connection apparatus 320 at Step F, according to an example embodiment of the present disclosure. In FIG. 12, the stopper 510 and the clamp 526 have been moved to respective open positions. Additionally, the downstream pipe connector section 512 has returned back to the first position 522. Further, the pipe connector section 502 is in the process of moving along the track 504 from the second position 508 to the first position 506 to prepare to connect the next irrigation pipe. During this time, the platform 302 is moved downstream, including the pipe connection apparatus 320, which causes the irrigation pipe 318 to be lowered into the trench 310 via the rail system 316.

As discussed, the use of the rail system 316 in conjunction with the pipe connection apparatus 320 provides a conveyor system for connecting and laying irrigation pipe with consistent and proper joint alignment. Generally, it takes about 15 to 60 seconds to perform the sequence 700 of FIGS. 7 and 8. Accordingly, on average the example pipe laying machine 301 may connect and lay approximately 85 pipes an hour or 850 pipes during the course of a ten hour work day. In other words, the example pipe laying machine continuously connects and lays per day about 17,000 feet (i.e., 3.2 miles) of irrigation pipe (assuming irrigation pipe with a 20 foot length).

### Downstream Pipe Positioning Embodiment

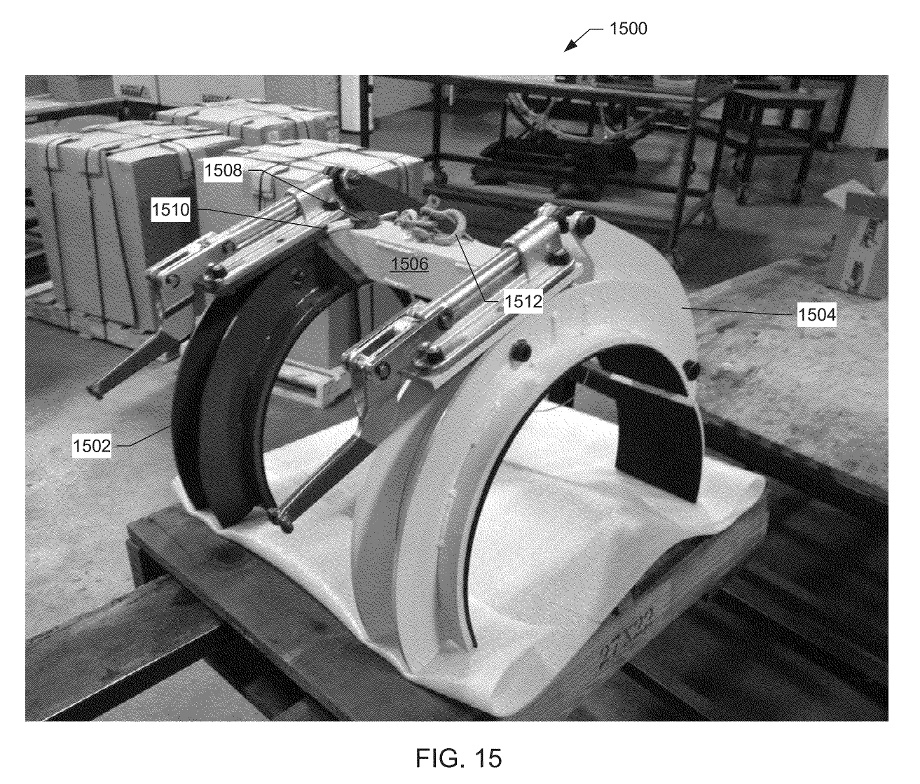

FIG. 13 shows a diagram of an example plunger 1302 configured to push and/or align the downstream irrigation pipe 318a with the upstream irrigation pipe 318b prior to connection by the pipe connection apparatus 320 of FIGS. 3 and 5. The example plunger 1302 may be used during Step C of the sequence 700 of FIGS. 7 and 8. The example plunger 1302 is connected to the rail system 316 via a track 1304 including a first end 1306 and the second end 1308. The track 1304 may be adjustable relative to the rail system 316 based on, for example, a length of irrigation pipe 318 to be connected. Further, the track 1304 may include stoppers 1310 to restrict movement of the plunger 1302 along the track 1304. For example, a first stopper 1310a may be added to the second end 1308 to prevent the plunger 1302 from pushing the downstream irrigation pipe 318a too far into (or too close to) the upstream irrigation pipe 318b. A second stopper 1310b may be added to the first end 1306 to reduce a distance the plunger 1302 has to move for shorter irrigation pipe.

The example plunger 1302 includes a plunger face 1312 configured to contact a face of an end (e.g., a bell end) of the downstream irrigation pipe 318a. The plunger face 1312 is dimensioned to engage substantially the entire circumference of the pipe end face to evenly apply pressure to the irrigation pipe 318. The plunger face 1312 may be replaced with a larger or smaller face depending, for example, on a diameter of the irrigation pipe 318. In some embodiments, the plunger face 1312 may operate in conjunction with the controller 334 to align a bevel of a spigot end of the downstream irrigation pipe 318a with a bell mouth of a bell end of the upstream irrigation pipe 318b. A proper alignment of the irrigation pipes 318 enables the pipe connection apparatus 320 to easily grip and connect the pipes 318.

The example plunger 1302 is controlled via the pneumatic controller 332 and/or the controller 334. For instance, to place the plunger 1302 against a bell end of the downstream irrigation pipe 318a, an operator may depress a plunger control button (e.g., a pusher foot valve), which causes the controller 334 to instruct the pneumatic controller 332 to apply fluid pressure to a plunger controller 1314. The example plunger controller 1314 amplifies the applied pressure within pneumatic lines 1316, causing the plunger 1302 to move upstream along the track 1304. The controller 334 is configured to continue to cause the plunger 1302 to move until an operator depresses the button. The plunger 1302 may also stop moving when it reaches the second end 1308 of the track 1304.

The example track 1304 may also include a spring (not shown) that returns the plunger 1302 to the first position 1306 when pneumatic pressure is removed. For example, an operator may depress the plunger control button, which causes the controller 334 to stop the pneumatic controller 332 from applying pressure to the pneumatic lines 1316. The pneumatic controller 332 may also cause the plunger controller 1314 to bleed the pneumatic lines 1316, further reducing pressure. The spring pushes the plunger 1302 to the first position 1306 after the pressure within the pneumatic lines 1316 is reduced.

### Pipe Laying Supply

FIG. 14 shows a diagram of an example magazine 1402 integrated with the pipe laying machine 301 of FIG. 3. The example magazine 1402 is configured to store irrigation pipe prior to placement on the rail system 316. The example magazine 1402 includes a first container 1404 and a second container 1406 configured to store irrigation pipe 318. During operation, an operator selects an irrigation pipe from the magazine 1402 for placement onto the rail system 316. For example, an operator (or two operators) lifts the irrigation pipe 318 onto the rail system 316 when the plunger 1302 is in the disengaged position. However, in other examples, the magazine 1402 may be configured to dispense the irrigation pipes 318 directly onto the downstream pipe holders 328 and/or the rail system 316. For example, the magazine 1402 may output the irrigation pipes 318 directly above or directly adjacent to the downstream pipe holders 328 and/or the rail system 316. In this embodiment, the magazine 1402 may include a stopper that prevents the irrigation pipe 318 from entering the downstream pipe holders 328 and/or the rail system 316 until the plunger 1302 is moved into the disengaged position.

A funnel may be attached and/or integrated with the first container 1404 and the second container 1406. Generally, forklift operators have a difficult time unloading irrigation pipe from a truck onto the relatively narrow containers 1404 and 1406. The funnel enables the irrigation pipes 318 to be placed into the containers 1404 and 1406 by a forklift. It should be appreciated that the irrigation pipes 318 are arranged prior to being loaded in the funnel so that the spigot ends and bell ends of the pipe face the same direction.

### Joint Clamp

FIGS. 15 and 16 show an example joint clamp 1500, according to an embodiment of the present disclosure. As discussed above, the joints between irrigation pipes may become stressed while the pipes are being lowered into a trench. While the example rail system 316 is configured to reduce joint stress to acceptable levels, the example joint clamp 1500 may also be used to reinforce the joint between irrigation pipes to reduce stress and maintain proper alignment. The example joint clamp 1500 of FIG. 15 includes a first joint clamp half 1502 and a second joint clamp half 1504.

Each of the halves 1502 and 1504 of FIG. 15 includes push/pull toggle clamps 1505 to easily open/close the respective joint clamp halves 1502 and 1504. The joint clamp halves 1502 and 1504 are removeably connected together via a connector section 1506, a tab 1508, and a key 1510. The connector section 1506 is integrated with or otherwise permanently connected to the joint clamp half 1504. The tab 1508 is integrated with or otherwise connected to the other joint clamp half 1502. To connect the halves 1502 and 1504 together, the tab 1508 is placed through a hole in the connector section 1506 enabling a top of the tab 1508 to emerge from the hole. The key 1510 is inserted into a hole within the tab 1508 to accordingly secure the two halves 1502 and 1504 together. It should be appreciated that in other examples, the joint clamp halves 1502 and 1504 may be connected via other components. For example, each of the joint clamp halves 1502 and 1504 may include connector members that are locked together via a clamp.

During use, the joint clamp 1500 is initially separated into the two joint clamp halves 1502 and 1504. As shown in FIG. 16, the joint clamp half 1502 is placed (e.g., closed) adjacent to a visual indicator 1602 on a spigot end of the downstream irrigation pipe 318a. The joint clamp half 1502 is positioned such that an inside edge 1604 of a clamp face 1606 is downstream and adjacent to the visual indicator 1602. This configuration prevents the downstream irrigation pipe 318a from being over-inserted past the visual indicator 1602 in instances where the pipe connection apparatus 320 FIGS. 3 and 5 may not include a stopper.

Returning to FIG. 15, the joint clamp half 1504 is placed on the upstream irrigation pipe 318b after it is connected to the downstream irrigation pipe 318a and the stopper 510 and the clamp 526 are opened. The joint half clamp 1504 is placed where the stopper 510 was located (i.e., at the front edge of the bell mouth 706 of the bell end 704 of the upstream irrigation pipe 318b of FIG. 7). The joint clamp half 1504 is aligned or rotated so that the hole within the connector section 1506 is positioned to engaged the tab 1508 of the already closed joint clamp half 1502. The key 1510 is placed in the tab 1508 after the connector section 1506 is connected to the tab 1508. At this point the joint clamp halves 1502 and 1504 are connected together across the joint of the upstream and downstream pipes 318, thereby securing the connected pipes. The joint clamp 1500 remains connected at the pipe joint until the pipes reach the bottom of the trench 310 at the end of the rail system 316. The joint clamp 1500 may be removed by opening the push/pull toggle clamps 1505. The joint clamp 1500 may then be returned to the platform 302 and separated into the halves 1502 and 1504 for the next joint installation.

In some embodiments, the joint clamp 1500 may include a connector 1512, which is connected via a chain or rope to the platform 302. The connector 1512 enables the joint clamp 1500 to be returned to the platform 302 after being removed from a joint. An operator (or mechanical reel) operating in conjunction with the crane 324 may pull the chain or rope back toward the platform 302 causing the joint clamp 1500 to be pulled up from the trench 310 onto the platform 302. In some embodiments, the chain or rope may include a pneumatic pressure line. In these embodiments, an operator may remotely disconnect the joint clamp 1500 from a joint and cause the joint clamp 1500 to be reeled back to the platform 302.

### Failsafe Embodiments

The example pipe laying machine 301 of FIGS. 3 to 12 may include one or more failsafe mechanisms to further prevent irrigation pipe joints from breaking or becoming overly stressed. As discussed above in conjunction with FIG. 3, the example pipe laying machine 301 includes a platform 302 pulled by a tractor 314. The driver of the tractor 314 and an operator of the pipe connection apparatus 320 work in tandem to ensure that the platform 302 does not move too quickly for the pipe connector section 502. Otherwise, the platform 302 may move downstream faster than the pipe connector section 502 is capable of moving upstream, breaking already formed upstream pipe joints. In some instances, the tractor 314 may include a speed governor that prevents the tractor 314 from moving faster than the pipe connector section 502. Additionally or alternatively, the controller 334 may determine a velocity of the platform 302 and accordingly cause the pipe connector section 502 to move at substantially the same velocity in the upstream direction.

The example controller 334 may also be configured to detect that the pipe connector section 502 is approaching the second or final position 508 on the track 504 and the downstream irrigation pipe 318a has not yet been properly or completely connected to the upstream irrigation pipe 318b (e.g., the visual indicator is not at the bell mouth of the upstream pipe). The controller 334 may send, for example, a message to the tractor 314 causing it to stop moving in the downstream direction before the pipe connector section 502 reaches the final position 508. The controller 334 may then complete the connection of the irrigation pipes 318. Such a failsafe configuration prevents upstream pipes from being disconnected when the pipe connector section 502 has reached the final position 508 of the track 504 before a pipe connection is made. The controller 334 may also cause the tractor 314 to stop moving if the downstream pipe connector section 512 has reached the end of the track 518 before a proper pipe connection is made.

The example controller 334 may further be configured to move the stopper 510 and/or the clamp 526 to open positions responsive to determining that a force to connect the irrigation pipes 318 exceeds a predetermined threshold. For instance, a bevel edge of the downstream irrigation pipe 318a may catch a side of the bell mouth of the upstream irrigation pipe 318b. However, the downstream pipe connector section 512 continues to move upstream placing additional stress on the stuck or caught the irrigation pipes 318. One or more force sensors on the stopper 510, the clamp 526, the pneumatic actuators 520, etc. may detect a force associated with the connection of the irrigation pipes 318. The force sensors are configured to transmit to the controller 334 signals indicative of measured force. Conditioned on detecting a force above a predetermined threshold, the controller 334 may cause the stopper 510 and/or the clamp 526 to open positions, thereby relieving force. The controller 334 may also cause the downstream pipe connector section 512 and/or the pipe connector section 502 to stop moving upstream. The controller 334 may further cause the tractor 314 to stop moving in the downstream direction so the misaligned pipe connection can be repaired.

### Automated Pipe Laying Machine Embodiment

The example pipe laying machine 301 of FIGS. 3 to 12 was discussed in conjunction with reference to operators. For instance, an operator drives the tractor 314, an operator controls the pipe connection apparatus 320 in conjunction with the controller 334 and the pneumatic controller 332, one or more operators load an irrigation pipe onto the rail system 316, and one or more operators installs and removes the joint clamp 1500. However, some or all of these operators may be replaced by automation. For example, the tractor 314 may be driven by, for example, the controller 334 using Global Positioning System (“GPS”) coordinates to steer. The controller 334 may also use a vision system to ensure the rail system 316 is properly aligned with the trench 310 by steering the tractor 314 in the appropriate direction.

The continuous motion of the pipe laying machine 301 is conducive to automation. The example controller 334 may drive the tractor 314 in conjunction with controlling the operation of the pipe connection apparatus 320. Such a configuration enables the velocity of the platform to be linked to the velocity of the connection sections 502 and 512 to ensure to platform 302 does not move too fast for the irrigation pipes to be completely connected. Such a configuration also enables the velocity of the platform 302 to be changed and optimized based on changing conditions that affect timing to connect the irrigation pipes 318.

In some instances, the controller 334 may operate in conjunction with a vision system to align the stopper 510 with a bell mouth of the upstream pipe 318b. For example, the controller 334 may close the stopper 510 when the bell mouth is about two to five feet from the bell mouth. The controller 334 uses force feedback from the stopper 510 to detect when the stopper 510 contacts the bell mouth and accordingly accelerates the pipe connector section 502. The controller 334 may also use the vision system to cause the plunger 1302 of FIG. 13 to position or align the downstream pipe 318a for the pipe connection apparatus 320 and control the positioning of the clamp 526 and the downstream pipe connector section 512. The controller 334 may also use the vision system to detect when a visual indicator on the downstream irrigation pipe 318a contacts a bell mouth of the upstream irrigation pipe 318b to release or open the stopper 510 and/or the clamp 526.

### Flowchart of the Example Process

FIGS. 17 and 18 illustrate a flow diagram showing an example procedure 1700 to connect and lay irrigation pipe, according to an example embodiment of the present disclosure. Although the procedure 1700 is described with reference to the flow diagram illustrated in FIGS. 17 and 18, it should be appreciated that many other methods of performing the steps associated with the procedure 1700 may be used. For example, the order of many of the blocks may be changed, certain blocks may be combined with other blocks, and many of the blocks described are optional. Further, the actions described in procedure 1700 may be performed among multiple components of the pipe laying machine 301 including, for example the rail system 316, the pipe connection apparatus 320, and/or the controller 334.

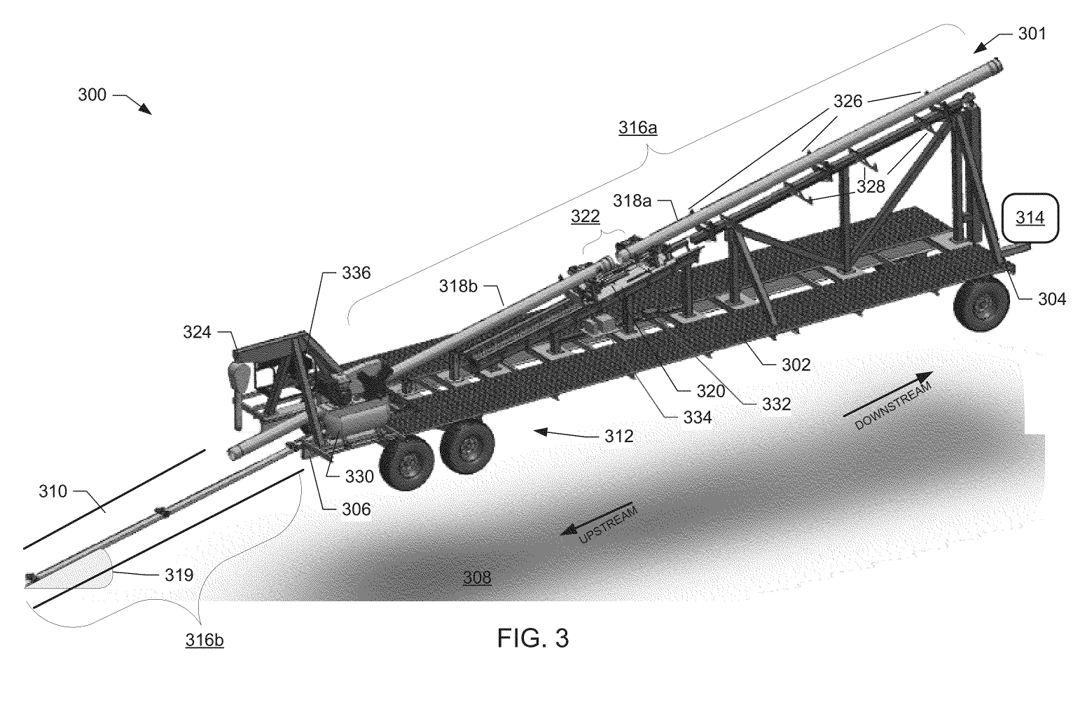

The example procedure 1700 of FIGS. 17 and 18 does not use the joint clamp 1500 of FIGS. 15 and 16. However, in other embodiments, the joint clamp 1500 may be used after the irrigation pipes 318 are connected together. The procedure 1700 begins as the pipe laying machine 301 of FIGS. 1 to 12 beings to continuously move downstream along or over a trench (block 1702). While the pipe laying machine 301 is moving, a check is performed to determine if an upstream pipe on the rail system 316 is in a specified position in relation to the pipe connection apparatus 320 of FIG. 3 (block 1704). Conditioned on the upstream pipe not being in the specified position, the pipe laying machine 301 continues moving downstream with no other action taking place. However, if the upstream pipe is in the specified position, the stopper 510 of FIG. 5 is moved to the closed position on the upstream pipe (block 1706).

After the stopper 510 is closed, a downstream pipe is positioned and aligned with the upstream pipe (block 1708). Positioning the downstream pipe may include loading the downstream pipe onto the rail system 316 from, for example, the magazine 1402 of FIG. 14 and/or the downstream pipe holders 328 of FIG. 3. Positioning the downstream pipe may also include using the plunger 1302 of FIG. 13 to push the downstream pipe in close proximity or adjacent to the upstream pipe (alternatively, gravity may pull the downstream pipe along the rail system 316 to the upstream pipe). Additionally, a spigot end of the downstream pipe and a bell mouth of a bell end of the upstream pipe are cleaned and/or lubricated (block 1710). In some instances, the lubrication may only be applied to an exterior surface of the spigot end of the downstream pipe. Alternatively, an adhesive may be applied to the upstream and/or the downstream pipe.

The example pipe laying machine 301 next determines if the stopper 510 has contacted the bell mouth of the upstream pipe (block 1712). If the stopper 510 has not contacted the bell mouth, the example procedure 1700 continues moving the pipe laying machine 301 downstream with no other action taking place. However, once the stopper 510 contacts the bell mouth, the pipe laying machine 301 moves the pipe connector section 502 upstream (block 1714). The pipe connector section 502 is moved upstream at a velocity that is equal to the downstream velocity of the pipe laying machine 301. In other embodiments, the pipe connector section 502 may be accelerated to a velocity less than the downstream velocity of the pipe laying machine 301 when the stopper 510 is moved to the closed position. Then, when the stopper 510 contacts the bell mouth, the pipe connector section 502 is accelerated to an upstream velocity that is substantially equal to the downstream velocity of the pipe laying machine 301.

After (or slightly before) the pipe connector section 502 begins moving upstream, the pipe laying machine 301 moves the clamp 526 to the closed position over the downstream pipe (block 1716). The pipe laying machine 301 then moves the downstream pipe connector section 512 upstream at a second velocity causing the spigot end of the downstream pipe to engage and fit inside of the bell mouth of the upstream pipe (block 1718). The pipe laying machine 301 (or an operator) determines if a visual indicator on the downstream pipe is in contact or adjacent to an edge of the bell mouth of the upstream pipe (block 1720). If the visual indicator is not aligned with the bell mouth, the pipe laying machine 301 continues to move the downstream pipe connector section 512 upstream (block 1718).

However, conditioned on the visual indicator being aligned with the edge of the bell mouth of the upstream pipe, the example pipe laying machine 301 opens the stopper 510 and the clamp 526 to release the connected irrigation pipe (block 1722). As the pipe laying machine 301 continues to move downstream, the connected released pipes are lowered in to the trench via the rail system 316 of FIG. 3. The example pipe laying machine 301 returns the pipe connector section 502 and the downstream pipe connector section 526 to respective first or initial positions to prepare for the next pipe connection (block 1724). The pipe laying machine 301 also determines if another downstream pipe is to be connected (block 1726). If there is another irrigation pipe available, the procedure returns to block 1702 and the pipe laying machine 301 continues moving downstream over or along the trench to connect and lay another pipe. Alternatively, if a fitting, such as an elbow, is to be connected next, the example procedure returns to block 1702 after the fitting has been installed. However, if there are no more pipes to connect and lay, the example procedure ends.

### CONCLUSION

It should be understood that various changes and modifications to the example embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An apparatus for laying pipe within the ground comprising:
a platform including a first end and a second end, the platform being configured to move relative to the ground; and
a pipe connector section configured to slide along a portion of length of the platform relative to the platform, the pipe connector section including:
an upstream stopper located adjacent to a first end of the pipe connector section, and
a downstream pipe connector section configured to slide along a portion of a length of the pipe connector section relative to the pipe connector section, the downstream pipe connector section including a downstream clamp,
wherein:
the upstream stopper is configured in a closed position to prevent a bell mouth of a bell end of an upstream pipe from passing through,
the downstream clamp is configured in a closed position to grip a spigot end of a downstream pipe, and
the downstream pipe connector section is configured to slide toward the upstream pipe to connect the bell end of the upstream pipe with the spigot end of the downstream pipe after the downstream clamp is placed into the closed position.

2. The apparatus of claim 1, wherein the platform is configured to move in a downstream direction at a first velocity and the pipe connector section is configured to move in an upstream direction at the first velocity such that the upstream pipe remains substantially stationary relative to the ground when the downstream pipe is being connected to the upstream pipe.

3. The apparatus of claim 2, wherein the pipe connector section is configured to move in the upstream direction after the upstream stopper is placed into the closed position and contacts the bell mouth of the upstream pipe.

4. The apparatus of claim 2, wherein the downstream pipe connector section is configured to move in the upstream direction at a second velocity greater than the first velocity while the pipe connector section is moving in the upstream direction at the first velocity to connect the downstream pipe to the upstream pipe.

5. The apparatus of claim 1, further comprising:
at least one platform track and a platform actuator configured to move the pipe connector section along the portion of the length of the platform; and
at least one pipe connector section track and a pipe connector section actuator configured to move the downstream pipe connector section along the portion of the length of the pipe connector section.

6. The apparatus of claim 1, wherein an interior face of the downstream clamp includes serrated teeth configured to pierce a surface of a portion of the spigot end of the downstream pipe to provide additional leverage to connect the downstream pipe to the upstream pipe.

7. The apparatus of claim 1, further comprising a rail having a first end positioned within a trench in the ground upstream from the platform and a second end adjacent to the second end of the platform, the rail being configured to support and guide the upstream pipe and the downstream pipe.

8. The apparatus of claim 7, wherein the rail includes sliders configured to enable the downstream pipe and the upstream pipe to move relative to the rail, the sliders being positioned at periodic intervals along the rail.

9. The apparatus of claim 7, wherein the slides are configured to be adjustable based on a diameter of the upstream pipe and the downstream pipe.

10. The apparatus of claim 7, wherein the rail is located in a middle of the platform such that the platform straddles the trench and is configured to be positioned at an incline to reduce at least one of stress and misalignment of a joint of the upstream pipe and the downstream pipe.

11. The apparatus of claim 10, wherein the incline is between 2 and 20 degrees.

12. The apparatus of claim 1, wherein the downstream pipe and the upstream pipe have a diameter between 3 inches and 27 inches.

13. A method for laying pipe within the ground comprising:
moving a platform in a downstream direction substantially continuously at a first velocity, the platform including a pipe connector section configured to slide along a portion of a length of the platform relative to the platform;
moving an upstream stopper to a closed position to prevent a bell mouth of a bell end of an upstream pipe from passing through, the upstream stopper being located on the pipe connector section;
moving the pipe connector section from a first position on the platform to a final position on the platform in an upstream direction at the first velocity after the upstream stopper contacts the bell mouth of the upstream pipe;
moving a downstream clamp to a closed position on a spigot end of a downstream pipe, the downstream clamp being located on a downstream pipe connector section configured to slide along a portion of a length of the pipe connector section relative to the pipe connector section; and
moving the downstream pipe connector section in the upstream direction at a second velocity from a first position on the pipe connector section to a second position on the pipe connector section to connect the downstream pipe to the upstream pipe while the pipe connector section is moving at the first velocity, the second velocity being greater than the first velocity.

14. The method of claim 11, wherein the second position on the pipe connector section corresponds to a location where an edge of the bell mouth of the bell end of the upstream pipe contacts a visual indicator on the spigot end of the downstream pipe.

15. The method of claim 11, wherein the downstream pipe connector section is stopped from moving responsive to the edge of the bell mouth of the bell end of the upstream pipe contacting the visual indicator on the spigot end of the downstream pipe.

16. The method of claim 11, wherein:
the downstream clamp is moved to the closed position after the upstream stopper contacts the bell mouth of the upstream pipe; and
the downstream pipe connector section is moved in the upstream direction at the second velocity responsive to moving the downstream clamp to the closed position.

17. The method of claim 11, further comprising:
conditioned on the downstream pipe connecting to the upstream pipe:
opening the downstream clamp and the upstream stopper,
moving the downstream pipe connector section to the first position on the pipe connector section, and
moving the pipe connector section to the first position on the platform.

18. A processor including a memory having instructions stored thereon that are configured when executed to cause the processor to at least:
move an upstream stopper to a closed position to prevent a bell mouth of a bell end of an upstream pipe from passing through the upstream stopper;
move a pipe connector section from a first position to a second position in an upstream direction at a first velocity after the upstream stopper contacts the bell mouth of the upstream pipe, the pipe connector section including the upstream stopper;
move a downstream clamp to a closed position on a spigot end of a downstream pipe, the downstream clamp being located on an downstream pipe connector section configured to slide along a portion of a length of the pipe connector section; and
move the downstream pipe connector section in the upstream direction at a second velocity from a first position on the pipe connector section to a second position on the pipe connector section to connect the downstream pipe to the upstream pipe while the pipe connector section is moving at the first velocity, the second velocity being greater than the first velocity.

19. The processor of claim 18, further comprising instructions stored thereon that are configured when executed to cause the processor to at least send a movement message instructing a propulsion system to move in a downstream direction substantially continuously at the first velocity, the propulsion system being configured to move a platform that includes the pipe connector section and the downstream pipe connector section.

20. The processor of claim 18, further comprising instructions stored thereon that are configured when executed to cause the processor to at least align and contact the spigot end of the downstream pipe with the bell mouth of the bell end of the upstream pipe after the upstream stopper is moved into the closed position.

21. The processor of claim 17, further comprising instructions stored thereon that are configured when executed to cause the processor to at least move a plunger from a first position to a second position, the plunger contacting a face of a bell end of the downstream pipe causing the downstream pipe to move upstream to align and contact the spigot end of the downstream pipe with the bell mouth of the bell end of the upstream pipe.

22. The processor of claim 18, further comprising instructions stored thereon that are configured when executed to cause the processor to at least:
determine the pipe connector section has reached the second position and the downstream pipe is not completely connected to the upstream pipe; and
send a movement message instructing a propulsion system to stop moving in a downstream direction, the propulsion system being configured to move a platform that includes the pipe connector section and the downstream pipe connector section.

23. The processor of claim 18, further comprising instructions stored thereon that are configured when executed to cause the processor to at least:
detect that a force to move at least one of the pipe connector section and the downstream pipe connector section is greater than a predetermined threshold;
responsive to detecting the force is greater than the predetermined threshold, move the downstream clamp from the closed position to an open position and move the upstream stopper from the closed position to an open position.
